(19) United States
(12) Patent Application Publication
(10) Pub. No.: US 2005/0020472 A1
(43) Pub. Date: Jan. 27, 2005

(54) Cellulase and cellulose containing detergent

(76) Inventors: Beatrix Kottwitz, Erkrath (DE); Fred Schambil, Monheim (DE)

Correspondence Address: WOODCOCK WASHBURN LLP, ONE LIBERTY PLACE, 46TH FLOOR, PHILADELPHIA, PA, 19103, US

(21) Appl. No.: 10/897,898

(22) Filed: Jul. 23, 2004

Related U.S. Application Data
(63) Continuation of application No. PCT/EP03/00269, filed on Jan. 14, 2003.

(30) Foreign Application Priority Data
Jan. 23, 2002 (DE) DE 102 02 390.5

(51) Int. Cl. C11D 3/00

(52) U.S. Cl. 510/473

(57) ABSTRACT

The present invention relates to methods and compositions for improving the secondary washing performance of cellulase containing detergents. In one embodiment, the detergent contains a cellulose which has been compacted under mechanical pressure and then granulated.

### CROSS REFERENCE TO RELATED APPLICATIONS

This application is a continuation of PCT/EP03/00269, filed Jan. 14, 2003, which claims the benefit of DE 102 02 390.5 filed Jan. 23, 2002, the complete disclosures of which are hereby incorporated by reference in their entirety.

### FIELD OF THE INVENTION

The present invention relates to detergents comprising cellulase which, in addition to stimulating the contribution of said cellulase to the washing performance of said detergent, comprise a special cellulose and also to corresponding washing processes and uses.

### BACKGROUND

Cellulases hydrolyze β-1,4-glycosidically linked glucose polymers. They include, inter alia, endo-1,4-β-glucanases (EC 3.2.1.4; CAS 9012-54-8; endoglucanases; EG) which act on the noncrystalline, amorphous structure inside the cellulose, and cellobiohydrolases (EC3.2.1.91; CAS 37329-65-0; CBH) which, starting from the nonreducing end of the glucan chain, release cellobiose units (β-1,4-glycosidically connected glucose dimers), also in the microcrystalline region. Of the latter, there are two immunologically distinct groups, CBH I and CBH II.

Cellobiases (EC 3.2.1.21; 1,4-β-glucosidases) are likewise involved in the complete degradation of cellulose in vivo because they hydrolyze the cellobiose units being produced. According to the invention, however, the term cellulases is intended to comprise only endoglucanases and cellobiohydrolases.

Cellulases, in particular EG and CBH I, are commonly used components of detergents for cleaning textiles. They exert a priority of functions therein: they contribute to the primary washing performance, i.e. the actual cleaning action, and also to the secondary washing performance of the detergent, and they have a finishing action.

Secondary washing performance means the ability to keep the dirt which has been removed from the fabric dissolved or suspended in the liquor, thus preventing it from being redeposited on the cleaned textile (antiredeposition action or graying inhibition).

The finish can include a plurality of effects on fabrics, in particular on cellulose-containing textiles such as, for example, cotton fabrics: the smoothing action on textile by removing cellulose aggregates still bound chemically (antipilling; AP), the softening action and color restoration. The softening effect on fabric is caused by removing broken-up fibrils of the fabric-forming cellulose which protrude from said fabric and by said fibrils not impeding the gliding of the intact fibers. The deepening of the optical color impression results from removing from the textile surface the uncolored fibrils produced by fiber damage and originating from inside the fibers. Another possible use is to treat in particular cotton-containing textiles with cellulases in order to exert a “stonewashed” effect on the former.

These various effects, an anti-redeposition assay and strategies following therefrom of developing cellulases for the use in detergents are reported, for example, in the article “Development of new Cellulases” by K.-H. Maurer, in the textbook Enzymes in detergency, published by Dekker, New York, 1997, pp. 175-202.

Various measurement methods have been developed in the prior art in order to assay via quantification of the various effects particular cellulases for their suitability for use in detergents. Thus, according to WO 96/34080 A1 for example, mixtures of those cellulases which produce in each case particular data in a secondary washing test and in a cellulose degradation assay are particularly suitable. In EP 540784 B1, for example, suitable cellulases contributing to antiredeposition are determined via the C¹⁴-CMC method.

Numerous cellulases, in particular of fungal or bacterial origin, for the use in detergents are known in the prior art. The cellulases most important to textile treatment are listed below.

The fungus Trichoderma is known as a producer of cellulases, in particular for the treatment of textile raw materials. Examples thereof are the EG from Trichoderma longibrachiatum (U.S. Pat. No. 6,017,870; WO 94/21801 A2). EP 586375 B1, WO 00/14208 A1, WO 00/37614 A2 and U.S. Pat. No. 6,268,328 disclose EG III variants, in particular from T. reesei, suitable for the use in detergents. T viride and T harzianum are also industrially utilized natural sources of cellulases, as are Aspergillus, in particular A. niger.

Thermostable enzymes with alkaline pH optima have been isolated from the fungus Humicola, in particular H. insolens, H. grisea, H. grisea thermoidea and H. lanuginosa. The applications GB 2075028 A and U.S. Pat. No. 4,435,307, for example, describe the enzymes of H. insolens and H. grisea var. thermoidea for use in detergents, which enzymes, according to this, exert in particular a fabric-softening effect. The properties displayed toward textiles, such as finishing, for example, but not color transfer inhibition, are indicated in WO 89/09259 A1 and EP 406314 B1, respectively, together with an appropriate measurement method. An endoglucanase-rich preparation of these enzymes, and developments thereof, are commercially available under the trade name Celluzyme® from Novozymes A/S, Bagsvaerd, Denmark. Other fungal cellulases are described by the same company in the application WO 96/29397 A1.

The products Endolase® and Carezyme® which are likewise available from Novozymes are the 50 kD EG and 43 kD EG, respectively, from H. insolens DSM 1800 whose nucleotide sequence has been described in WO 91/17243 A1 and which accordingly can be produced in its pure form. It has been improved, for example, via point mutagenesis according to WO 94/07998 A1 to improve its primary washing performance and its finishing. WO 96/27649 A1, for example, discloses the use of this cellulase together with cationic dye fixatives. According to the application WO 99/02633 A1, both cellulases have again been improved by removing the cellulose-binding domains in combination with bleaches in appropriate detergents. Such detergents are disclosed in WO 99/02637 A1, for example.

The application WO 97/14804 A1 describes cellulase preparations from the fungi Myceliophthora, Myriococcum, Melanocarpus, Sporotrichum and Chaetomium for use, inter alia, in detergents. Among these, the following four enzymes derived from Melanocarpus albomyces CBS 685.95 are supposedly particularly suitable for this purpose: the 20 kD endoglucanase (EG), the 50 kD cellulase, the 50 kD cellulase B and the “protein with CBD”. The graying-inhibiting action of said 20 kD EG from Myriococcum and Melanocarpus is described in the application WO 01/32817 A1, for example. Said enzyme is available under the trade name Ecostone® from AB Enzymes, Finland.

Genetically engineered developments of fungal EG, inter alia from Humicola insolens, Fusarium oxysporum, Trichoderma reesei and Myceliphthora thermophile, for use in detergents, which have, inter alia, improved color transfer inhibition, are disclosed in WO 95/24471 A1, for example. The application WO 98/12307 A1 also discloses performance-improved cellulase variants.

Other alkaline cellulases usable in detergents are obtained, for example, from various basidiomycetes species (U.S. Pat. No. 5,972,872). The fungi Rhizopus oryzae CP96001, Mucor circinelloides CP99001, Phycomyces nitens CP99002 also produce alkaline cellulases (WO 00/24879 A1). Chrysosporium lucknowense VKM F-3500D and related species produce neutral and/or alkaline cellulases (WO 98/15633 A1 and U.S. Pat. No. 5,811,381).

Examples of bacterial sources of cellulases for use in detergents, which have been described, are Bacillus sp., Cellulomonas sp. and actinomycetes. Thus, for example, bacterial cellulases having an alkaline pH optimum and, compared to the primary washing performance, contributing advantageously to the secondary washing performance are produced by Bacillus sp. KSM 635 and related species (EP 271004 A1 and EP 339550 A2). The same applicant discloses in EP 270974 A2 and EP 269977 A2 further Bacillus cellulases acting in the alkaline pH range (from various Bacillus sp.: strains KSM-344, KSM-597 and those with intermediate numbers, and also alkaline cellulase E II and E III). DE 2247832 A1 describes thermostable cellulases having a pH optimum between 5 and 10 from Bacillus N1 (ATCC 21832) and Bacillus N4 (ATCC 21833). GB 2095275 A describes for the use in detergents further alkaline cellulases from Bacillus N (FERM 1138 to 1141) and “cellulase 212” from Aeromonas and even from the hepatopancreas of a marine mollusk. Further Bacillus alkaline cellulases are disclosed in WO 94/01532 A1 and, respectively, EP 1001018 A2 (from Bacillus sp. AC13 NCIMB 40482), and EP 468464 A2 (from Bacillus sp. SD402). According to the application WO 91/10732 A1, the alkaline endoglucanases obtainable from Bacillus lautus NCIMB 40250 and from related strains are likewise suitable for use in detergents. WO 93/12224 A1 characterizes two further Bacillus enzymes referred to as carboxymethylcellulase 5430 and 5812. Cleaning agents containing Cellulomonas sp. No. 301-A cellulase are described in DE 3322950 A1. Examples of cellulases from actinomycetes which have been described include a 35 kD cellulase (U.S. Pat. No. 6,190,899 B₁) and 36 kD cellulase (WO 00/09707 A1 and U.S. Pat. No. 6,187,577 B1).

The application WO 96/34108 A2, and, respectively, EP 739982 A1 and WO 97/34005 A1 disclose in the form of the cellulase preparations from Bacillus sp. CBS 670.93, and, respectively, Bacillus sp. CBS 669.93 bacterial cellulases which, according to WO 96/34092 A2 has an advantageous ratio of tensile strength loss (TSL; fiber degradation) to antipilling properties (AP; secondary washing performance). Accordingly, they are particularly suitable for the use in detergents, according to WO 96/34092 A2. The Bacillus sp. CBS 670.93 enzyme is available under the trade name Puradax® from Genencor Int., Inc., Palo Alto, Calif., USA.

Archaebacterial endoglucanase is disclosed in U.S. Pat. No. 6,074,867, for example.

Further commercial products from Novozymes are Cellusoft® for biopolishing in the context of textile production and DeniMax® for achieving the “stone washed” effect of cotton cloth. Under these names, series with in each case different preparations are supplied, partly with neutral, partly with alkaline pH and partly mixed with other enzymes such as α-amylase, for example.

Further commercial products from Genencor are liquid preparations with neutral to alkaline pH under the name “Genencor detergent cellulase L” and a neutral cellulase in the form of IndiAge® Neutra.

Examples of further commercial products from AB Enzymes are the enzymes Econase® and Ecopulp®.

Various routes have already been taken in order to improve the contributions of cellulases to the secondary washing performance of corresponding detergents. These approaches are against the background of, on the one hand, the cellulase activity acting on the fiber, i.e. the material to be cleaned, but, on the other hand, with the performance being too low, removed fibers remaining on the piece of textile as graying. This is the balance of tensile strength loss (TSL; fiber degradation) and antipilling properties (AP; secondary washing performance), defined in WO 96/34092 A2.

To cover various performance aspects of cellulases, mixtures of cellulases are also used, thus, for example, according to the application WO 95/02675 A1 in which a cellulase which has a good primary washing performance and a cellulase which provides color restoration are used. However, this mixture has not been optimized for secondary washing performance.

The secondary washing performance of a cellulase-containing detergent is improved by naturally occurring cellulases which have an appropriately advantageous performance profile, such as the enzymes disclosed in WO 96/34092 A2, and, respectively, EP 739982 A1 and EP 540784 B1, for example.

According to WO 96/34080 A1, an optimal washing result is achieved by using mixtures of two cellulases one of which provides a good performance in the cellulose degradation assay and the other one of which provides a good contribution to the secondary washing performance of the detergent.

The patent EP 747471 B1 describes the treatment of a natural mixture of fungal cellulases, for example those from Trichoderma, with proteases. The removal achieved therewith of the cellulose-binding domains from the cellobiohydrolases, according to this, improves the contribution of the resulting cellulase mixture to the secondary washing performance of corresponding detergents. WO 96/23928 A1 teaches to remove the cellulose-binding domain from cellulases, that is from both EG and CBH, and thereby to generate truncated molecules which improve the secondary washing performance of detergents.

In order to counteract graying, the cellulase is preferably combined with “antiredeposition additives” such as, for example, inorganic, in particular zeolitic builder substances (DE 4325882 A1). The identical purpose is also served by a number of low molecular weight compounds such as, for example, hydroxyalkanephosphonic acid or salts thereof (DE 19520101 A1), sophorolipid in lactone form (FR 2740779 A1) or a dianionic surfactant with (a) a sulfate group and (b) a sulfate or sulfonate group (WO 98/00501 A1).

Familiar antiredeposition additives are also cellulose derivatives, in particular in combination with cellulases. Cellulose derivatives mean those compounds in which substituents are linked via ether bonds to the hydroxyl groups of the glucose monomers of celluloses. These include also those in which formally the entire hydroxyl group has been substituted, the “deoxy-celluloses”. Cationically, anionically or nonionically modified celluloses, in particular methyl cellulose, carboxymethylcellulose (CMC), methylhydroxycellulose, methylhydroxyethylcellulose or methylhydroxypropylcellulose and also copolymers of (meth)acrylic acid and maleic acid are used. According to the application DE 3329400 A1, for example, mixtures of cellulose derivatives are used for the purpose of antiredeposition.

According to EP 934997 A1, cellulose derivatives of this kind act synergistically together with cellulases, in particular with respect to the secondary washing performance.

The increase in washing performance, in particular the secondary washing performance of a detergent, by combining cellulase, a cellulose derivative and a further component, namely a polymer capable of removing dirt, is disclosed in the application DE 10037126 A1.

The use of chemically unmodified celluloses for improving the secondary washing performance of cellulase-containing detergents, however, has not yet been described in the prior art.

A new trend in the development of more powerful detergents and cleaning agents is compacting to give “shaped bodies” or tablets. In order for such shaped bodies to dissolve rapidly in the wash liquor, they contain, in addition to the ingredients responsible for the cleaning performance, “tablet disintegrants” or disintegrating agents. Described as such are, inter alia, also cellulose, cellulose mixtures and cellulose derivatives which, by the mechanism of absorbing liquid, predominantly via swelling and/or wicking effects, cause the shaped body to disintegrate when contacted with water and the active ingredients to be released.

For this, only the following examples should be listed:
The detergent shaped body disclosed in the application WO 98/54283 A1, for example, is distinguished by comprising a proportion of swellable, water-insoluble disintegration aids such as pure cellulose or a cellulose derivative, and a gas-producing effervescent system.
The disintegrant disclosed in the application WO 98/55575 A1 is a mixture of coarse-grained cellulose with a microcrystalline cellulose.
The application WO 99/13042 A1 provides detergent and cleaning agent shaped bodies with improved solubility by the various forms of cellulose usable as disintegrating agents, such as, for example, microcrystalline cellulose, but also cellulose derivatives, and mixtures with other biopolymers such as alginates or starches together with other hydrophilic components being spatially separated from the hydrophobicity-causing substances in the compressed material.

The application WO 98/40462 A1 discloses for application in detergent shaped bodies a cellulose which has not been used in detergents previously and which is an extremely powerful disintegrant. The subject matter there is a compressed material which disintegrates in liquid and which comprises, in addition to the ingredients to be released, finely divided, mechanically compressed, comparatively little worked-up and chemically unmodified cellulose-containing material and optionally a proportion of noncompacted cellulose. The application WO 98/40463 A1, for example, discloses detergent shaped bodies together with a suitable granulation method, which exhibit a supreme dissolution behavior, owing to the size distribution of the disintegrant granules present therein. Materials suitable for this are many known tablet disintegrants, inter alia cellulose derivatives and the only slightly worked-up cellulose disclosed in WO 98/40462 A1.

A contribution of these celluloses usable as disintegrants in tablets to the secondary washing performance of corresponding detergents has not been described in the prior art.

Thus, various cellulases are known which contribute to the performance of detergents, including too the secondary washing performance thereof. In order to stimulate this performance, various routes have been taken, for example the selection, specific mixture or modification of microbial cellulases or the combination with other ingredients, for example various cellulose derivatives. The use of special celluloses suitable as disintegrants, however, has not been contemplated for this purpose previously.

### SUMMARY

It was the object to find another possibility of improving the contribution of a cellulase to the performance of detergents. More specifically, it was intended to improve the secondary washing performance based on cellulase. This object should be regarded as being achieved if such a new possibility were to stimulate the contribution of at least one cellulase to the performance of a detergent.

Partial objects were to find formulations for detergents of this kind, in particular regarding the concentration of the performance-enhancing agent and of the cellulase, and to define corresponding processes and uses for washing textiles.

Surprisingly, the compound found having such a performance-enhancing effect is a cellulose which, at least partially, has been compacted under mechanical pressure and then granulated. Said effect was particularly apparent when the cellulose was present in the form of a very finely divided cellulose-containing material. It is furthermore advantageous for the cellulose not to be chemically modified. Such celluloses have previously been known only as tablet disintegrants.

### DETAILED DESCRIPTION

The present application therefore relates to any detergent comprising cellulase, which is characterized in that it additionally comprises a cellulose which is present, at least partially, in a form which has been compacted under mechanical pressure and then granulated, preferably as a very finely divided cellulose-containing material; further preference is given to said cellulose not being chemically modified and having disintegrating action. Further embodiments of this subject matter of the invention relate to preferred forms of application, ingredients and/or dosages. Without having to investigate the biochemical foundations of this effect, the above effect can be readily comprehended on the basis of the application examples of the present application.

The invention further relates to corresponding processes and uses for washing textiles and for stimulating the contribution of a cellulase to the washing performance, in particular to the secondary washing performance, of a detergent.

The present application relates to any detergent comprising cellulase, which is characterized in that it additionally comprises a cellulose which is present, at least partially, in a form which has been compacted under mechanical pressure and then granulated, preferably as a very finely divided cellulose-containing material.

According to the invention, any cellulases defined at the outset, both endoglucanases and cellobiohydrolases, can be used. Among these, preference is given to endoglucanases. Cellulases which can be used according to the invention may be of both fungal and bacterial origin. Examples of cellulases which can be used according to the invention are the enzymes illustrated in the introduction of the present application. They are preferably those cellulases which, from the start, have a detectable contribution to the secondary washing performance of a detergent of the invention. These include, for example, the products obtainable under the trade names Celluzyme®, Carezyme® and Endolase®, both individually and as mixtures. They include in particular the cellulases or cellulase mixtures described in the applications WO 96/34092 A2, EP 739982 A1, WO 96/34080 A1, WO 96/34108 A2, WO 97/34005 A1, EP 747471 B1, WO 96/23928 A1, WO 95/24471 A1, WO 97/14804 A1, EP 739982 A1 and WO 01/32817 A1 or mixtures thereof. Further, likewise preferred cellulases are disclosed, for example, in the application WO 96/29397 A1, in particular the endoglucanase from Thielavia terrestris. Preferably, the cellulases have performance-enhancing modifications which are described in the application WO 98/12307 A1, for example.

The cellulase important to the invention may be added to the detergent of the invention in any formulations which appear to be expedient or which are common. These include, for example, liquid, solid or encapsulated formulations. Such formulations are illustrated in more detail in connection with the other, optionally present enzymes further below.

Celluloses mean β-1,4-glycosidically linked glucose polymers. Such polymers are usually obtained from plant raw materials, in particular wood. The production thereof is described in specialist textbooks, for example in Rompp Lexikon Chemie, Version 2.0, Stuttgart, N.Y., Georg Thieme Verlag, 1999. Celluloses usable according to the invention have been, at least partially, compacted under mechanical pressure and then granulated. They are preferably present in the form of a very finely divided cellulose-containing material.

Such a mechanical modification is carried out, for example, on the raw material predominantly composed of cellulose, for example wood. This is described in detail in the application WO 98/40462 A1, for example. According to this, a finely divided cellulose-containing material which has been compressed under mechanical pressure and then granulated is obtained by defibrating wood chips, for which the two embodiments TMP—for “thermo-mechanical pulp”—and CTMP—for “chemo-thermo-mechanical pulp”—are disclosed. In this process, lignins, resins and other wood constituents are not completely removed from the material, and the fibrillar basic structure is also retained so that it is also possible to speak of a coarse, crosslinked cellulose. According to the application in question, this material is compressed in a granulation process to granular particles.

This compression of TMP and CTMP produces particles which, in the compressed state, have an average diameter of 50 μm. In addition, there may also be portions of uncompressed cellulose, for example in order to exert a wicking effect during the dissolving process; likewise, a portion of the material may also be in the fibrillated state. The granules containing the compressed particles and optionally also uncompressed cellulose have a density of from 0.5 to 1.5 g/cm³, and the granular particles have a size of from 0.2 to 6.0 mm, in particular from 0.4 to 1.5 mm. The performance increase of the invention can be observed with all of these particles, i.e. with average particle sizes of both 50 μm and 1.5 mm. The evidence for the inventive action of such a material is provided by the examples of the present application.

It is also possible to introduce to this process celluloses which, prior to their compacting, have undergone a specific chemical modification, for example the quantitative or stoichiometrically comprehensible substitution of some hydroxyl groups of the glucose monomers present in the cellulose by other substituents, for example by a sulfite group, the etherification, esterification, nitration thereof or other chemical derivatization reactions.

Further suitable celluloses are described, for example, in the article in SÖFW-Journal, volume 125, p. 62. They are available, for example, under the trade name ARBOCEL® from J. Rettenmaier & Söhne GmbH & Co., Rosenberg, Germany; for example under the following type designations: ARBOCEL®-B and ARBOCEL®-BC (beech cellulose), ARBOCEL®-BE (beech sulfite cellulose), ARBOCEL®-B-SCH (cotton cellulose), ARBOCEL®-FIC (spruce cellulose) and other ARBOCEL® types (ARBOCEL®-TF-30-HG).

In order to display the action of the invention, the granules produced may be added to the agents in question without further work-up. Optionally, the agents in question may be compounded further. Relevant embodiments will be set forth further below.

According to the invention, the increase in any performance aspect, in particular in the performance aspects, illustrated at the outset, of the cellulases obtained, is desired. Particular preference is given to enhancing antiredeposition inhibition.

The test on whether a selected cellulose is able to stimulate the contribution of a cellulase to the washing performance, in particular to the secondary washing performance, of the agent, can be conducted simply by adding said cellulose to a relevant detergent and measuring the washing performance achieved. Formulations of this kind are known to the skilled worker and will be illustrated in more detail further below. Suitable measurement methods are likewise known from the prior art. They are described, for example, in the documents mentioned at the outset, in particular WO 96/34080 A1, EP 350098 A1, EP 271004 A1, WO 96/34092 A2 and EP 747471 B1.

The methods applied in the examples of the present application is particularly advantageous: according to this, standardized textiles are washed in a dirty wash liquor with a cellulase-containing detergent formulation and, for comparison, with a corresponding cellulase-free formulation. After washing, the degree of whiteness of the washed textiles is measured in comparison with that of barium sulfate, the latter of which is set to 100%. In order to obtain objective values, the measurement is carried out in a spectrometer. The results obtained are given as percent remission, i.e. as percentages in comparison with barium sulfate and can be compared via these. The higher the value, the lower is the redeposition of dirt particles.

In a preferred embodiment, a detergent of the invention is characterized in that the cellulose has not been chemically modified.

This means specific chemical modifications, for example the abovementioned derivatizations via the quantitative or stoichiometrically comprehensible substitution of hydroxyl groups by other substituents. However, this preferred embodiment does not take into account that any work-up method, in particular those comprising thermal and/or chemical partial steps, may result per se in certain chemical alterations on a material. This relates in particular to the mentioned generation of TMP or CTMP as intermediate step of generating the cellulose important to the invention prior to its compacting. These chemical alterations are not regarded as being specific chemical modifications.

However, the stimulating action of the cellulose important to the invention is presumably to be attributed to the change in the three dimensional nature of cellulose, caused by mechanical modification, rather than to the chemical identity of the substituents linked to the polyacetal backbone. The mechanically modified cellulose used in the examples has also not specifically been chemically modified or derivatized during the course of its preparation.

In a preferred embodiment, a detergent of the invention is characterized in that the cellulose has disintegrating action.

This means the disintegrating action the cellulose would exert if it were incorporated into a compacted microscopic shaped body, since this is the most prominent feature, which can be monitored macroscopically, of most of the celluloses obtained via the mechanical modification illustrated above and is a physicochemical property which is independent of whether or not it has actually been incorporated in a shaped body when used according to the invention. The mechanically modified cellulose used in the examples also has this property and is described as tablet disintegrant in the abovementioned applications. Another advantage of this embodiment is the fact that a cellulose of this kind can exert a double function when used in cellulase-containing detergent tablets (see below), namely (1.) disintegrating the tablets in question and (2.) stimulating according to the invention the secondary washing performance of the agent in question, which can be attributed to the cellulase obtained.

In a preferred embodiment, a detergent of the invention is characterized in that it is present overall in the form of a powder.

Such a powder comprises the components designed for said detergent and illustrated in detail further below, for example as fine powders or in a coarse-grained, compacted or uncompacted form, in the shape of granules, particles obtained from extrudates or by other preparation processes and, in addition, the above-described cellulose, preferably in the form of mixed-in granular particles. In another embodiment, the cellulose particles are compacted together with other components of the agent or said other components are compacted with one another. Thus it is useful, for example, to compound the enzymes present in the agent together by methods known per se, for example by, where appropriate, joint granulation and coating with a protective layer.

In a preferred embodiment, a detergent of the invention is characterized in that it is present overall in a compacted form.

Such a compacting involves compacting all individual components of the agent, including the cellulose important to the invention, preferably in granular form, as a whole. Thus, the agent is present in the form of a homogeneous mixture of macroscopically conceivable particles which in turn comprise all detergent components. This kind of compacting can be obtained by extrusion, for example.

In a preferred embodiment, a detergent of the invention is characterized in that it has been compacted into shaped bodies.

Such a compression or compaction process of the complete mixtures of the ingredients into macroscopic shaped bodies which can be used as detergent tablet or cleaning agent tablet is established in the prior art and disclosed in WO 98/40463 A1, for example. According to the application WO 98/40462 A1, particular preference is given here to those shaped bodies which hold together merely due to said compression and without further binders or adhesives. Thus, contact with water results in rapid swelling of the finely divided cellulose particles and, after the formation of tears and influx of more water promoted thereby, to rapid, complete disintegration. This compact may additionally, outside of the granular particles present therein, also comprise a proportion of uncompacted cellulose. According to the invention, the cellulose important to the invention, present in said compact, causes in the wash liquor an increase in the antiredeposition action of the cellulase present.

In a particularly preferred embodiment, the cellulose important to the invention promotes the dissolving process of these shaped bodies so that it has the double function already mentioned above. Such agents of the invention may alternatively also comprise two populations of cellulose important to the invention, a first one having the task of promoting the secondary washing performance of the cellulase present, and a second one serving as a tablet disintegrant. They may be chemically identical. It may be useful here, for example by following the teaching of the application WO 99/13042 A1 to present the two populations spatially separated from one another in the shaped body.

Detergent granules and/or tablets of this kind may be prepared by the methods described in the prior art, for example according to WO 98/40463 A1 or WO 98/54283 A1. They may be single phase or multiphase. For this purpose, preferably all the components—where appropriate each of one layer—are mixed together in a mixer and the mixture is compressed by means of conventional tablet presses, for example eccentric presses or rotary presses, with compressive forces in the range from about 50 to 100 kN/cm², preferably at 60 to 70 kN/cm². It may be advantageous, in particular in the case of multilayer tablets, for at least one layer to be precompressed. This is preferably carried out with compressive forces between 5 and 20 kN/cm², in particular at 10 to 15 kN/cm². A tablet produced in this way preferably has a weight of from 10 g to 50 g, in particular from 15 g to 40 g. The three-dimensional shape of the tablets is as desired and may be circular, oval or angular, with intermediate shapes also being possible.

In an increasingly preferred embodiment, a detergent of the invention is characterized in that the proportion of the cellulose present is from 1 to 10% by weight, from 1.5 to 8.75% by weight, from 2 to 7.5% by weight, from 2.5 to 6.25% by weight and from 3 to 5% by weight, of the detergent.

The performance-enhancing effect of the cellulose used is confirmed in the examples of the present application for a concentration range from 1 to 5% by weight.

In a preferred embodiment, a detergent of the invention is characterized in that it additionally comprises one or more further cellulases.

These are, correspondingly preferably, all of the cellulases illustrated above or cellulase preparations from natural or genetically modified organisms. Following, for example, the teaching of the applications WO 95/02675 A1 and WO 96/34080 A1, preference is given to those mixtures in which the various performance aspects, i.e. the effects illustrated at the outset, primary washing performance, secondary washing performance and finishing, or other effects of the cellulases present are complementing each other, thus covering a broad performance profile. In addition, preference is given here to the cellulose important to the invention stimulating, in addition to the antiredeposition effect, also other aspects, in particular the aspects illustrated at the outset. This may be checked via the measurements methods mentioned above or illustrated in the relevant documents. A combination of various cellulases may also be justified on grounds of different substrate specificities or possible regulations.

In a preferred embodiment, a detergent of the invention is characterized in that the total activity of the cellulase or the cellulase mixture present is from 0.5 CMC-U to 40 CMC-U, increasingly preferably from 0.75 to 35 CMC-U, 1 to 30 CMC-U, 1.5 to 25 CMC-U and particularly preferably from 2 CMC-U to 20 CMC-U, per 100 g of the detergent.

Since machine detergents, depending on the degree of soiling and the type of appliance, are usually used at concentrations of from 50 to 200 g of the detergent per 50 to 1001 of wash liquor, the corresponding resulting concentration values are in a range from 0.125 to 40 CMC-U per application and 0.00125 to 0.8 CMC-U per 1 of wash liquor.

The cellulolytic activity is determined by way of carboxymethylcellulose (CMC) hydrolysis as CMC units (CMC-U; CMCase activity). The determination by the PAHBAH method is based on modifications of the method described by M. Lever in Anal. Biochem., 47 (1972), pp. 273-279 and Anal. Biochem., 81 (1977), pp. 21-27 and is carried out as follows: 250 μl of a 2.5 percent strength by weight solution of carboxymethylcellulose (purchased from Sigma, C-5678) in 50 mM glycine buffer (pH 9.0) are incubated with 250 μl of a solution of the enzyme to be tested or with the enzyme-containing agent at 40° C. for 30 min. Subsequently, 1.5 ml of a 1 percent strength by weight solution of p-hydroxybenzoic acid hydrazide (PAHBAH) in 0.5M NaOH, containing 1 mM bismuth nitrate and 1 mM potassium sodium tartrate, are added and the solution is heated to 70° C. for 10 min. After cooling (2 min 0° C.), absorption at 410 nm is determined at room temperature in comparison with a blank (e.g. by using a Uvikon® 930 spectrophotometer). The blank used is a solution which has been prepared like the measurement solution but with the difference that both PAHBAH solution and CMC solution are added in this order only after incubation of the enzyme, followed by heating to 70° C. In this way, possible activities of the cellulase to media components are also recorded in the blank and subtracted from the total activity of the sample so that only the activity to CMC is actually determined. 1 CMC-U corresponds to the amount of enzyme which generates 1 μmol of glucose per minute under these conditions.

In a preferred embodiment, a detergent of the invention is characterized in that the cellulase or cellulase mixture has a ratio of tensile strength loss (TSL) to antipilling properties (AP) of less than 1.

As described above and confirmed in WO 96/34080 A1, mixtures of this kind cover an action spectrum of cellulases in detergents, which exceeds the secondary washing performance, in a fabric-protecting manner.

In a preferred embodiment, a detergent of the invention is characterized in that it additionally comprises one or more celluloses and/or one or more further cellulose derivatives obtained by chemical modification of cellulose.

Additional celluloses or, as illustrated above, cellulose derivatives obtained via chemical modification, for example esterification, etherification or substitution of the hydroxyl groups, which may be used, for example, as separate preparations or as cogranules together with the cellulose important to the invention, fulfill, in addition to the performance increase of cellulase, in particular regarding its contribution to the secondary washing performance, further functions in the agent of the invention. These include, for example:
stimulating a further cellulase function;
acting as a disintegrant if the agent has been compacted into a shaped body; according to WO 98/55575 A1, for example, the joint granulation of microcrystalline cellulose with nonmicrocrystalline cellulose as disintegrant is advantageous in order to keep low the formation of residues on the material to be cleaned;
as means for stabilizing or compounding, in particular for encapsulating enzymes; or
as thickeners of liquid agents.

In a preferred embodiment thereof, a detergent of the invention is characterized in that at least one of the additionally present other celluloses or cellulose derivatives is suitable as disintegrant.

This makes it possible for the agents in question to be compacted, as illustrated above, into shaped bodies with an advantageous dissolving behavior.

The present invention can be put into practice by any presentations for detergents, which are established in the prior art and/or appropriate. Included here are, for example, solid, pulverulent, gel-like or paste-like agents, where appropriate also composed of a plurality of phases, compressed or uncompressed; further examples include: extrudates, granules, tablets or pouches, packaged both in large containers and in portions.

Agents of the invention may consist of a plurality of phases, for example in order to release the active compounds present therein in a time- and/or space-resolved manner. Said phases may be in various or in the same state of aggregation. Examples thereof are tablets, preferably powders or granules, which can be prepared by simply mixing the individual components, and also emulsions having separately emulsified active compounds or solutions containing encapsulated components. Sensitive ingredients such as, for example, enzymes or bleaches, may be added separately, where appropriate later, in production or only for application.

Apart from the ingredients already illustrated, an agent of the invention may comprise further ingredients customary in detergents, as described in detail in the prior art. These include, for example, enzyme stabilizers, surfactants, for example nonionic, anionic or amphoteric surfactants, bleaches, builders and, where appropriate, further customary ingredients which are illustrated below.

The nonionic surfactants used are preferably alkoxylated, advantageously ethoxylated, in particular primary alcohols having preferably from 8 to 18 carbon atoms and, on average, from 1 to 12 mol of ethylene oxide (EO) per mole of alcohol, in which the alcohol radical can be linear or, preferably, methyl-branched in the 2-position or can comprise linear and methyl-branched radicals in a mixture as are customarily present in oxo alcohol radicals. Particular preference is, however, given to alcohol ethoxylates containing linear radicals of alcohols of native origin having from 12 to 18 carbon atoms, for example from coconut, palm, tallow fatty or oleyl alcohol, and, on average, from 2 to 8 EO per mole of alcohol. Preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO, and mixtures of these, such as mixtures of C₁₂₋₁₄-alcohol having 3 EO and C₁₂₋₁₈-alcohol having 5 EO. The degrees of ethoxylation given are statistical averages which may be an integer or a fraction for a specific product. Preferred alcohol ethoxylates have a narrowed homolog distribution (narrow range ethoxylates, NRE). In addition to these nonionic surfactants, fatty alcohols having more then 12 EO can also be used. Examples thereof are tallow fatty alcohol having 14 EO, 25 EO, 30 EO or 40 EO.

A further class of preferably used nonionic surfactants which are used either as the sole nonionic surfactant or in combination with other nonionic surfactants are alkoxylated, preferably ethoxylated or ethoxylated and propoxylated, fatty acid alkyl esters, preferably having from 1 to 4 carbon atoms in the alkyl chain, in particular fatty acid methyl esters.

A further class of nonionic surfactants which can advantageously be used are the alkyl polyglycosides (APG). Alkyl polyglycosides which may be used satisfy the general formula RO(G)_{z}, in which R is a linear or branched, in particular methyl-branched in the 2-position, saturated or unsaturated, aliphatic radical having from 8 to 22, preferably from 12 to 18 carbon atoms, and G is the symbol which stands for a glycose unit having 5 or 6 carbon atoms, preferably for glucose. The degree of glycosylation z is here between 1.0 and 4.0, preferably between 1.0 and 2.0 and in particular between 1.1 and 1.4. Preference is given to using linear alkyl polyglucosides, i.e. alkyl polyglycosides in which the polyglycosyl radical is a glucose radical, and the alkyl radical is an n-alkyl radical.

Nonionic surfactants of the amine oxide type for example N-cocoalkyl-N,N-dimethylamine oxide and N-tallow alkyl-N,N-dihydroxyethylamine oxide, and of the fatty acid alkanolamides type may also be suitable. The proportion of these nonionic surfactants is preferably no more than that of the ethoxylated fatty alcohols, in particular no more than half thereof.

Further suitable surfactants are polyhydroxy fatty acid amides of the formula (II) 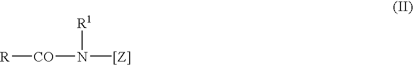
in which RCO is an aliphatic acyl radical having from 6 to 22 carbon atoms, R¹ is hydrogen, an alkyl or hydroxyalkyl radical having from 1 to 4 carbon atoms and is a linear or branched polyhydroxyalkyl radical having from 3 to 10 carbon atoms and from 3 to 10 hydroxyl groups. The polyhydroxy fatty acid amides are known substances which can usually be obtained by reductive amination of a reducing sugar with ammonia, an alkylamine or an alkanol amine and subsequent acylation with a fatty acid, a fatty acid alkyl ester or a fatty acid chloride.

The group of polyhydroxy fatty acid amides also includes compounds of the formula (III) 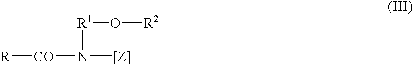
in which R is a linear or branched alkyl or alkenyl radical having from 7 to 12 carbon atoms, R¹ is a linear, branched or cyclic alkyl radical or an aryl radical having from 2 to 8 carbon atoms, and R² is a linear, branched or cyclic alkyl radical or an aryl radical or an oxy-alkyl radical having from 1 to 8 carbon atoms, where C₁₋₄-alkyl or phenyl radicals are preferred, and [Z] is a linear polyhydroxyalkyl radical whose alkyl chain is substituted with at least two hydroxyl groups, or alkoxylated, preferably ethoxylated or propoxylated, derivatives of this radical.

[Z] is preferably obtained by reductive amination of a reducing sugar, for example glucose, fructose, maltose, lactose, galactose, mannose or xylose. The N-alkoxy- or N-aryloxy-substituted compounds may be converted, for example by reaction with fatty acid methyl esters in the presence of an alkoxide as catalyst, into the desired polyhydroxy fatty acid amides.

The anionic surfactants used are, for example, those of the sulfonate and sulfate type. Suitable surfactants of the sulfonate type are preferably C₉₋₁₃-alkylbenzene sulfonates, olefin sulfonates, i.e. mixtures of alkene and hydroxyalkane sulfonates, and disulfonates, as obtained, for example, from C₁₂₋₁₈-monoolefins having a terminal or internal double bond by sulfonation with gaseous sulfur trioxide and subsequent alkaline or acidic hydrolysis of the sulfonation products. Also suitable are alkane sulfonates which are obtained from C₁₂₋₁₈-alkanes, for example, by sulfochlorination or sulfoxidation with subsequent hydrolysis or neutralization. Likewise suitable are also the esters of α-sulfo fatty acids (ester-sulfonates), for example the α-sulfonated methyl esters of hydrogenated coconut, paln kernel or tallow fatty acids.

Further suitable anionic surfactants are sulfated fatty acid glycerol esters. Fatty acid glycerol esters mean the mono-, di- and triesters, and mixtures thereof, as are obtained during the preparation by esterification of a monoglycerol with from 1 to 3 mol of fatty acid or during the transesterification of triglycerides with from 0.3 to 2 mol of glycerol. Preferred sulfated fatty acid glycerol esters are here the sulfination products of saturated fatty acids having from 6 to 22 carbon atoms, for example of capronic acid, caprylic acid, capric acid, myristic acid, lauric acid, palmitic acid, stearic acid or behenic acid.

Preferred alk(en)yl sulfates are the alkali metal, and in particular the sodium, salts of sulfuric half-esters of C₁₂-C₁₈-fatty alcohols, for example coconut fatty alcohol, tallow fatty alcohol, lauryl, myristyl, cetyl or stearyl alcohol or of C₁₀-C₂₀-oxo alcohols and those half-esters of secondary alcohols of these chain lengths. Further preferred are alk(en)yl sulfates of said chain length which comprise a synthetic, petroleum-based straight-chain alkyl radical which have analogous degradation behavior to the equivalent compounds based on fatty chemical raw materials. From a washing performance viewpoint, preference is given to C₁₂-C₁₆-alkyl sulfates and C₁₂-C₁₅-alkyl sulfates, and C₁₄-C₁₅-alkyl sulfates. 2,3-Alkyl sulfates are also suitable anionic surfactants.

The sulfuric monoesters of straight-chain or branched C₇₋₂₁-alcohols ethoxylated with from 1 to 6 mol of ethylene oxide, such as 2-methyl-branched C₉₋₁₁-alcohols having, on average, 3.5 mol of ethylene oxide (EO) or C₁₂₋₁₈-fatty alcohols having from 1 to 4 EO, are also suitable. Owing to their high foaming behavior, they are used in cleaning agents only in relatively small amounts, for example in amounts up to 5% by weight, usually from 1 to 5% by weight.

Further suitable anionic surfactants are also the salts of alkylsulfosuccinic acid, which are also referred to as sulfosuccinates or as sulfosuccinic esters and which are monoesters and/or diesters of sulfosuccinic acids with alcohols, preferably fatty alcohols and, in particular, ethoxylated fatty alcohols. Preferred sulfosuccinates contain C₈₋₁₈-fatty alcohol radicals or mixtures thereof. Particularly preferred sulfosuccinates contain a fatty alcohol radical derived from ethoxylated fatty alcohols, which are themselves nonionic surfactants (see below for description). In this connection, sulfosuccinates whose fatty alcohol radicals are derived from ethoxylated fatty alcohols having a narrowed homolog distribution are, in turn, particularly preferred. Likewise, it is also possible to use alk(en)ylsuccinic acid having preferably from 8 to 18 carbon atoms in the alk(en)yl chain or salts thereof.

Further suitable anionic surfactants are, in particular, soaps. Saturated fatty acid soaps such as the salts of lauric acid, myristic acid, palmitic acid, stearic acid, hydrogenated erucic acid and behenic acid, and, in particular, soap mixtures derived from natural fatty acids, for example coconut, palm kernel or tallow fatty acids, are suitable.

The anionic surfactants including soaps may be present in the form of their sodium, potassium or ammonium salts, and as soluble salts of organic bases such as mono-, di- or triethanolamine. The anionic surfactants are preferably present in the form of their sodium or potassium salts, in particular in the form of the sodium salts.

The surfactants may be present in the detergents of the invention in an overall amount of from preferably 5% by weight to 50% by weight, in particular from 8% by weight to 30% by weight, based on the finished agent.

In another embodiment, the detergents are bleach-containing detergents.

Of the compounds which serve as bleaches and produce H₂O₂ in water, sodium percarbonate, sodium perborate tetrahydrate and sodium perborate monohydrate are of particular importance. Other bleaches which can be used are, for example, peroxopyrophosphates, citrate perhydrates and H₂O₂-producing peracidic salts or peracids, such as persulfates or persulfuric acid. Also useful is the urea peroxohydrate percarbamide which can be described by the formula H₂N—CO—NH₂.H₂O₂. They may also comprise bleaches from the group of organic beaches. Typical organic bleaches are the diacyl peroxides such as, for example, dibenzoyl peroxide. Further typical organic bleaches are the peroxy acids, specific examples being alkyl peroxy acids and aryl peroxy acids. Preferred representatives are peroxy benzoic acid and its ring-substituted derivatives, such as alkylperoxybenzoic acids, but also peroxy-α-naphthoic acid and magnesium monoperphthalate, the aliphatic or substituted aliphatic peroxy acids such as peroxylauric acid, peroxystearic acid, ε-phthalimidoperoxycaproic acid (phthalimidoperoxyhexanoic acid, PAP), o-carboxybenzamidoperoxycaproic acid, N-nonenylamidoperadipic acid and N-nonenylamidopersuccinate, and aliphatic and araliphatic peroxydicarboxylic acids such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyldi(6-aminopercaproic acid) may be used.

The bleach content of the agents may be from 1 to 40% by weight and, in particular, from 10 to 20% by weight, using advantageously perborate monohydrate or percarbonate.

In order to achieve improved bleaching action in cases of washing at temperatures of 60° C. and below, and in particular in the case of laundry pretreatment, bleach activators can be incorporated into the detergent and cleaning agent moldings. Bleach activators which can be used are compounds which, under perhydrolysis conditions, give aliphatic peroxocarboxylic acids having preferably from 1 to 10 carbon atoms, in particular from 2 to 4 carbon atoms, and/or substituted or unsubstituted perbenzoic acid. Substances which carry O-and/or N-acyl groups of said number of carbon atoms and/or substituted or unsubstituted benzoyl groups are suitable. Preference is given to plurally acylated alkylenediamines, in particular tetraacetylethylenediamine (TAED), acylated triazine derivatives, in particular 1,5-diacetyl-2,4-dioxohexahydro-1,3,5-triazine (DADHT), acylated glycoluriles, in particular 1,3,4,6-tetraacetylglycoluril (TAGU), N-acylimides, in particular N-nonanoylsuccinimide (NOSI), acylated phenolsulfonates, in particular n-nonanoyl- or isononanoyloxybenzene sulfonate (n- or iso-NOBS), acylated hydroxycarboxylic acids such as triethyl-O-acetyl citrate (TEOC), carboxylic anhydrides, in particular phthalic anhydride, isatoic anhydride and/or succinic anhydride, carboxamides such as N-methyldiacetamide, glycolide, acylated polyhydric alcohols, in particular triacetin, ethylene glycol diacetate, isopropenyl acetate, 2,5-diacetoxy-2,5-dihydrofuran and the enol esters disclosed in German patent applications DE 196 16 693 and DE 196 16 767, and acetylated sorbitol and mannitol, or mixtures thereof described in European patent application EP 0 525 239 (SORMAN), acylated sugar derivatives, in particular pentaacetylglucose (PAG), pentaacetylfructose, tetraacetylxylose and octaacetyllactose, and acetylated, optionally N-alkylated glucamine or gluconolactone, triazole or triazole derivatives and/or particulate caprolactams and/or caprolactam derivatives, preferably N-acylated lactams, for example N-benzoylcaprolactam and N-acetylcaprolactam, which are disclosed in international patent applications WO 94/27970, WO 94/28102, WO 94/28103, WO 95/00626, WO 95/14759 and WO 95/17498. The hydrophilically substituted acyl acetals disclosed in German patent application DE 196 16 769 and the acyl lactams described in German patent application DE 196 16 770 and in international patent application WO 95/14075 are likewise used with preference. It is also possible to use the combinations of conventional bleach activators disclosed in German patent application DE 44 43 177. Nitrile derivatives such as cyanopyridines, nitrile quats, e.g. N-alkylammoniumacetonitriles, and/or cyanamide derivatives may also be used. Preferred bleach activators are sodium 4-(octanoyloxy)benzenesulfonate, n-nonanoyl- or isononanoyloxybenzene sulfonate (n- or iso-NOBS), undecenoyloxybenzenesulfonate (UDOBS), sodium dodecanoyloxybenzenesulfonate (DOBS), decanoyloxybenzoic acid (DOBA, OBC 10) and/or dodecanoyloxybenzenesulfonate (OBS 12), and N-methylmorpholinium acetonitrile (MMA). Such bleach activators may be present in the customary quantitative range from 0.01 to 20% by weight, preferably in amounts from 0.1 to 15% by weight, in particular 1% by weight to 10% by weight, based on the total composition.

In addition to the conventional bleach activators or instead of them, it is also possible for “bleach catalysts” to be present. These substances are bleaching-enhancing transition metal salts or transition metal complexes such as, for example, Mn, Fe, Co, Ru or Mo salene complexes or carbonyl complexes. Mn, Fe, Co, Ru, Mo, Ti, V and Cu complexes containing N-containing tripod ligands, and Co, Fe, Cu and Ru amine complexes are also suitable as bleach catalysts, preference being given to using those compounds described in DE 197 09 284 A1.

The agents of the invention usually contain one or more builders, in particular zeolites, silicates, carbonates, organic cobuilders and, where no ecological reasons oppose their use, also phosphates.

Compounds which may be mentioned here are crystalline, layered sodium silicates of the general formula NaMSiₓO₂ₓ₊₁.yH₂O, where M is sodium or hydrogen, x is a number from 1.6 to 4, preferably from 1.9 to 4.0, and y is a number from 0 to 20, and preferred values for x are 2, 3 or 4. Crystalline phyllosilicates of this kind are described, for example, in European patent application EP 0 164 514. Preferred crystalline phyllosilicates of the formula indicated are those where M is sodium and x adopts the values 2 or 3. In particular, both β- and δ-sodium disilicates Na₂Si₂O₅.yH₂O are preferred. Compounds of this kind are sold, for example, under the name SKS® (Clariant). Thus, SKS-6® is primarily a δ-sodium disilicate having the formula Na₂Si₂O₅.yH₂O, and SKS-7® is primarily the β-sodium disilicate. Reacting the δ-sodium disilicate with acids (for example citric acid or carboxylic acid) gives kanemite NaHSi₂O₅.yH₂O, sold under the names SKS-9® and, respectively, SKS-10® (Clariant). It may also be advantageous to use chemical modifications of said phyllosilicates. The alkalinity of the phyllosilicates, for example, can thus be suitably influenced. Phyllosilicates doped with phosphate or with carbonate have, compared to the δ-sodium disilicate, altered crystal morphologies, dissolve more rapidly and display an increased calcium binding ability, compared to δ-sodium disilicate. Thus, phyllosilicates of the general empirical formula xNa₂O.ySiO₂.zP₂O₅ where the x-to-y ratio corresponds to a number from 0.35 to 0.6, the x-to-z ratio to a number from 1.75 to 1200 and the y-to-z ratio to a number from 4 to 2800 are described in patent application DE 196 01 063. The solubility of the phyllosilicates may also be increased by using particularly finely granulated phyllosilicates. It is also possible to use compounds of the crystalline phyllosilicates with other ingredients. Compounds which may be mentioned here are in particular those with cellulose derivatives which have advantageous disintegrating action and are used in particular in detergent tablets, and those with polycarboxylates, for example citric acid, or polymeric polycarboxylates, for example copolymers of acrylic acid.

It is also possible to use amorphous sodium silicates having an Na₂O:SiO₂ modulus of from 1:2 to 1:3.3, preferably from 1:2 to 1:2.8, and in particular from 1:2 to 1:2.6, which have delayed dissolution and secondary detergent properties. The dissolution delay relative to conventional amorphous sodium silicates can have been induced by various means, for example by surface treatment, compounding, compaction/compression or by overdrying. Within the scope of this invention, the term “amorphous” also means “X-ray amorphous”. This means that in X-ray diffraction experiments the silicates do not give the sharp X-ray refractions typical of crystalline substances, but instead, at best, one or more maxima of these scattered X-rays, which have a width of several degree units of the diffraction angle. However, particularly good builder properties will very likely result if, in electron diffraction experiments, the silicate particles give poorly defined or even sharp diffraction maxima. This is to be interpreted to the effect that the products have microcrystalline regions with a size from 10 to a few hundred nm, preference being given to values up to at most 50 nm and in particular up to at most 20 nm. Particular preference is given to compressed/compacted amorphous silicates, compounded amorphous silicates and overdried X-ray amorphous silicates.

A finely crystalline, synthetic zeolite containing bonded water, which may be used where appropriate, is preferably zeolite A and/or P. As zeolite P, zeolite MAP® (commercial product from Crosfield) is particularly preferred. However, zeolite X and mixtures of A, X and/or P are also suitable. A product which is commercially available and can be used with preference within the scope of the present invention is, for example, also a co-crystallizate of zeolite X and zeolite A (approx. 80% by weight zeolite X), which is sold by CONDEA Augusta S.p.A. under the trade name VEGOBOND AX® and can be described by the formula
nNa₂O.(1−n)K₂O.Al₂O₃.(2-2.5)SiO₂.(3.5-5.5)H₂O

Suitable zeolites have an average particle size of less than 10 μm (volume distribution; measurement method: Coulter counter) and preferably contain from 18 to 22% by weight, in particular from 20 to 22% by weight, of bonded water.

Use of the generally known phosphates as builder substances is of course also possible, provided such a use should not be avoided for ecological reasons. Among the multiplicity of commercially available phosphates, the alkali metal phosphates are the most important in the detergents and cleaning agents industry, with pentasodium or pentapotassium triphosphate (sodium or potassium tripolyphosphate) being particularly preferred.

In this connection, alkali metal phosphates is the collective term for the alkali metal (in particular sodium and potassium) salts of the various phosphoric acids, it being possible to differentiate between metaphosphoric acids (HPO₃)ₙ and orthophosphoric acid H₃PO₄ as well as higher molecular weight representatives. The phosphates combine several advantages: they act as alkali carriers, prevent lime deposits on machine parts and lime incrustations in fabrics and, moreover, contribute to the cleaning performance.

The industrially important pentasodium triphosphate, Na₅P₃O₁₀ (sodium tripolyphosphate), is a nonhygroscopic, white, water-soluble salt which is anhydrous or crystallizes with 6 H₂O and is of the general formula NaO—[P(O)(ONa)—O]ₙ where n=3. In 100 g of water, about 17 g of the salt which is free of water of crystallization dissolve at room temperature, approx. 20 g dissolve at 60° C., and about 32 g dissolve at 100° C.; if the solution is heated at 100° C. for two hours, about 8% of orthophosphate and 15% of diphosphate form due to hydrolysis. In the preparation of pentasodium triphosphate, phosphoric acid is reacted with soda solution or sodium hydroxide solution in a stoichiometric ratio, and the solution is dewatered by spraying. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is available commercially, for example, in the form of a 50% strength by weight solution (>23% P₂O₅, 25% K₂O). The potassium polyphosphates are used widely in the detergents and cleaning agents industry. In addition, sodium potassium tripolyphosphates also exist which can likewise be used within the scope of the present invention. These form, for example, when sodium trimetaphosphate is hydrolyzed with KOH:
(NaPO₃)₃+2KOH→Na₃K₂P₃O₁₀+H₂O

According to the invention, these can be used exactly as sodium tripolyphosphate, potassium tripolyphosphate or mixtures of these two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used according to the invention.

Organic cobuilders which can be used in the detergents and cleaning agents of the invention are, in particular, polycarboxylates or polycarboxylic acids, polymeric polycarboxylates, polyaspartic acid, polyacetals, optionally oxidized dextrins, further organic cobuilders (see below), and phosphonates. These classes of substance are described below.

Useful organic builder substances are, for example, the polycarboxylic acids usable in the form of their sodium salts, the term polycarboxylic acids meaning those carboxylic acids which carry more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use should not be avoided for ecological reasons, and mixtures thereof. Preferred salts are the salts of the polycarboxylic acids such as citric acid, adipic acid, succinic acid, glutaric acid, tartaric acid, sugar acids, and mixtures thereof.

It is also possible to use the acids per se. In addition to their builder action, the acids typically also have the property of an acidifying component and thus also serve to establish a lower and milder pH of detergents or cleaning agents, as long as the pH resulting from the mixture of the remaining components is not desired. Particular mention should be made here of systemically and environmentally safe acids such as citric acid, acetic acid, tartaric acid, malic acid, lactic acid, glycolic acid, succinic acid, glutaric acid, adipic acid, gluconic acid and any mixtures thereof. However, mineralic acids, in particular sulfuric acid, or bases, in particular ammonium or alkali metal hydroxides, may also serve as pH regulators. The agents of the invention contain such regulators in amounts of preferably not more than 20% by weight, in particular from 1.2% by weight to 17% by weight.

Suitable builders are also polymeric polycarboxylates; these are, for example, the alkali metal salts of polyacrylic acid or of polymethacrylic acid, for example those having a relative molecular mass of from 500 to 70 000 g/mol.

The molar masses given for polymeric polycarboxylates are, for the purposes of this specification, weight-average molar masses, Mw, of the respective acid form, determined in principle by means of gel permeation chromatography (GPC), using a UV detector. The measurement was made against an external polyacrylic acid standard which, owing to its structural similarity toward the polymers studied, provides realistic molecular weight values. These figures differ considerably from the molecular weight values obtained using polystyrenesulfonic acids as the standard. The molar masses measured against polystyrenesulfonic acids are usually considerably higher than the molar masses given in this specification.

Suitable polymers are, in particular, polyacrylates which preferably have a molecular mass of from 2000 to 20 000 g/mol. Owing to their superior solubility, preference in this group may be given in turn to the short-chain polyacrylates which have molar masses of from 2000 to 10 000 g/mol, and particularly preferably from 3000 to 5000 g/mol.

Also suitable are copolymeric polycarboxylates, in particular those of acrylic acid with methacrylic acid and of acrylic acid or methacrylic acid with maleic acid. Copolymers which have proven to be particularly suitable are those of acrylic acid with maleic acid which contain from 50 to 90% by weight of acrylic acid and from 50 to 10% by weight of maleic acid. Their relative molecular mass, based on free acids, is generally from 2000 to 70 000 g/mol, preferably 20 000 to 50 000 g/mol and in particular 30 000 to 40 000 g/mol. The (co)polymeric polycarboxylates may be used either as powders or as aqueous solutions. The (co)polymeric polycarboxylate content of the agents may be from 0.5 to 20% by weight, in particular 1 to 10% by weight.

To improve the solubility in water, the polymers may also contain allylsulfonic acids such as, for example, allyloxybenzenesulfonic acid and methallylsulfonic acid as monomers.

Particular preference is also given to biodegradable polymers of more than two different monomer units, for example those which contain, as monomers, salts of acrylic acid and of maleic acid, and vinyl alcohol or vinyl alcohol derivatives, or those which contain, as monomers, salts of acrylic acid and of 2-alkylallylsulfonic acid, and sugar derivatives.

Further preferred copolymers are those which preferably have, as monomers, acrolein and acrylic acid/acrylic acid salts or acrolein and vinyl acetate.

Further preferred builder substances which may be mentioned are also polymeric aminodicarboxylic acids, their salts or their precursor substances. Particular preference is given to polyaspartic acids or salts and derivatives thereof.

Further suitable builder substances are polyacetals which can be obtained by reacting dialdehydes with polyolcarboxylic acids having from 5 to 7 carbon atoms and at least 3 hydroxyl groups. Preferred polyacetals are obtained from dialdehydes such as glyoxal, glutaraldehyde, terephthalaldehyde and mixtures thereof and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary processes, for example acid-catalyzed or enzyme-catalyzed processes. The hydrolysis products preferably have average molar masses in the range from 400 to 500 000 g/mol. Preference is given here to a polysaccharide having a dextrose equivalent (DE) in the range from 0.5 to 40, in particular from 2 to 30, where DE is a common measure of the reducing action of a polysaccharide compared with dextrose, which has a DE of 100. It is possible to use both maltodextrins having a DE between 3 and 20 and dried glucose syrups having a DE between 20 and 37, and also “yellow dextrins” and “white dextrins” with higher molar masses in the range from 2000 to 30 000 g/mol.

The oxidized derivatives of such dextrins are their reaction products with oxidizing agents which are able to oxidize at least one alcohol finction of the saccharide ring to the carboxylic acid function. Particularly preferred organic builders for agents of the invention are oxidized starches and derivatives thereof of the applications EP 472 042, WO 97/25399 and EP 755 944, respectively.

Oxydisuccinates and other derivatives of disuccinates, preferably ethylenediamine disuccinate, are also further suitable cobuilders. Here, ethylenediamine N,N′-disuccinate (EDDS) is preferably used in the form of its sodium or magnesium salts. In this connection, further preference is also given to glycerol disuccinates and glycerol trisuccinates. Suitable use amounts in zeolite-containing and/or silicate-containing formulations are between 3 and 15% by weight.

Further organic cobuilders which may be used are, for example, acetylated hydroxycarboxylic acids or salts thereof, which may also be present, where appropriate, in lactone form and which contain at least 4 carbon atoms and at least one hydroxyl group and at most two acid groups.

A further class of substance having cobuilder properties is the phospbonates. These are, in particular, hydroxyalkane and aminoalkane phosphonates. Among the hydroxyalkane phosphonates, 1-hydroxyethane 1,1-diphosphonate (HEDP) is of particular importance as a cobuilder. It is preferably used as sodium salt, the disodium salt being neutral and the tetrasodium salt being alkaline (pH 9). Suitable aminoalkane phosphonates are preferably ethylenediaminetetramethylene phosphonate (EDTMP), diethylenetriamine-pentamethylene phosphonate (DTPMP) and higher homologs thereof. They are preferably used in the form of the neutral sodium salts, for example as the hexasodium salt of EDTMP or as the hepta- and octasodium salt of DTPMP. Here, preference is given to using HEDP as builder from the class of phosphonates. In addition, the aminoalkane phosphonates have a marked heavy metal-binding capacity. Accordingly, particularly if the agents also contain bleaches, it may be preferable to use aminoalkane phosphonates, in particular DTPMP, or mixtures of said phosphonates.

In addition, all compounds which are able to form complexes with alkaline earth metal ions can be used as cobuilders.

The agents of the invention may contain builder substances, where appropriate, in amounts of up to 90% by weight, and preferably contain them in amounts of up to 75% by weight. Detergents of the invention have builder contents of, in particular, from 5% by weight to 50% by weight.

Solvents which may be used in the gelatinous to paste-like compositions of detergents of the invention are, for example, from the group of monohydric or polyhydric alcohols, alkanolamines or glycol ethers, as long as they are miscible with water in the given concentration range. Preferably, the solvents are selected from ethanol, n- or i-propanol, butanols, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, dii sopropylene glycol monomethyl or mono ethyl ether, methoxy, ethoxy or butoxy triglycol, 1-butoxyethoxy-2-propanol, 3-methyl-3-methoxybutanol, propylene glycol t-butyl ether, and mixtures of these solvents.

Solvents may be used in the gelatinous to paste-like detergents of the invention in amounts of between 0.1 and 20% by weight, but preferably below 15% by weight, and in particular below 10% by weight.

To adjust the viscosity, one or more thickeners or thickening systems may be added to the composition of the invention. These high molecular weight substances which are also called swell(ing) agents. usually soak up the liquids and swell in the process, converting ultimately into viscous true or colloidal solutions.

Suitable thickeners are inorganic or polymeric organic compounds. Inorganic thickeners include, for example, polysilicic acids, clay minerals, such as montmorillonites, zeolites, silicas and bentonites. The organic thickeners are from the groups of natural polymers, modified natural polymers and completely synthetic polymers. Such natural polymers are, for example, agar-agar, carrageen, tragacanth, gum arabic, alginates, pectins, polyoses, guar flour, carob seed flour, starch, dextrins, gelatins and casein. Modified natural substances which are used as thickeners are primarily from the group of modified starches (see above) and celluloses.

The thickeners may be present in an amount up to 5% by weight, preferably from 0.05 to 2% by weight, and particularly preferably from 0.1 to 1.5% by weight, based on the finished composition.

The detergent of the invention may, where appropriate, comprise, as further customary ingredients, sequestering agents, electrolytes and further excipients such as optical brighteners, graying inhibitors, color transfer inhibitors, foam inhibitors, dyes and/or fragrances, and antimicrobial active substances and/or UV-absorbing agents.

The textile detergents of the invention may contain, as optical brighteners, derivatives of diaminostilbenedisulfonic acid or alkali metal salts thereof. Suitable are, for example, salts of 4,4′-bis(2-anilino-4-morpholino-1,3,5-triazinyl-6-amino)stilbene-2,2′-disulfonic acid or similarly constructed compounds which carry a diethanolamino group, a methylamino group, an anilino group or a 2-methoxyethylamino group instead of the morpholino group. In addition, brighteners of the substituted diphenylstyryl type may be present, for example the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-mentioned optical brighteners may also be used.

In addition to the ingredients important to the invention, illustrated above, agents of the invention may comprise further graying inhibitors. These have the function of keeping the soil detached from the textile fiber in suspension in the liquor. Suitable for this purpose are water-soluble colloids, usually organic in nature, for example starch, glue, gelatin, salts of ethercarboxylic acids or ethersulfonic acids of starch or of cellulose, or salts of acidic sulfuric esters of cellulose or of starch. Water-soluble polyamides containing acidic groups are also suitable for this purpose. Furthermore, starch derivatives such as aldehyde starches and, where appropriate, further cellulose derivatives (see above) such as cellulose ethers, carboxymethylcellulose (Na salt), methylcellulose, hydroxyalkylcellulose and mixed ethers such as methylhydroxyethylcellulose, methylhydroxypropylcellulose, methylcarboxymethylcellulose, and mixtures thereof can also be used. Graying inhibitors are used, for example, in amounts of from 0.1 to 5% by weight, based on the agents.

Soil-release active ingredients or soil repellents are usually polymers which, when used in a detergent, impart soil-repellent properties to the laundry fiber and/or assist the ability of the other detergent constituents to detach soil.

Soil-release active ingredients which are particularly effective and have been known for a long time are copolyesters having dicarboxylic acid, alkylene glycol and polyalkylene glycol units. Examples thereof are copolymers or mixed polymers of polyethylene terephthalate and polyoxyethylene glycol (DT 16 17 141, and, respectively, DT 22 00 911). German Offenlegungsschrift DT 22 53 063 discloses acidic agents containing, inter alia, a copolymer of a dibasic carboxylic acid and an alkylene or cycloalkylene polyglycol. German documents DE 28 57 292 and DE 33 24 258 and European patent EP 0 253 567 describe polymers of ethylene terephthalate and polyethylene oxide terephthalate and the use thereof in detergents. European patent EP 066 944 relates to agents containing a copolyester of ethylene glycol, polyethylene glycol, aromatic dicarboxylic acid and sulfonated aromatic dicarboxylic acid in particular molar ratios. European patent EP 0 185 427 discloses methyl-or ethyl group end-group-capped polyesters having ethylene and/or propylene terephthalate and polyethylene oxide terephthalate units, and detergents containing such a soil-release polymer. European patent EP 0 241 984 relates to a polyester which contains, in addition to oxyethylene groups and terephthalic acid units also substituted ethylene units and glycerol units. European patent EP 0 241 985 discloses polyesters which contain, in addition to oxyethylene groups and terephthalic acid units, 1,2-propylene, 1,2-butylene and/or 3-methoxy-1,2-propylene groups, and glycerol units and which are end-group-capped with C₁- to C₄-alkyl groups. European patent application EP 0 272 033 discloses polyesters having polypropylene terephthalate and polyoxyethylene terephthalate units, which are at least partially end-group-capped by C₁₋₄-alkyl or acyl radicals. European patent EP 0 274 907 describes sulfoethyl end-group-capped terephthalate-containing soil-release polyesters. According to European patent application EP 0 357 280, sulfonation of unsaturated end groups produces soil-release polyesters having terephthalate, alkylene glycol and poly-C₂₋₄-glycol units. International patent application WO 95/32232 relates to acidic, aromatic polyesters capable of detaching soil. International patent application WO 97/31085 discloses nonpolymeric soil-repellent active ingredients for materials made of cotton, which have a plurality of functional units: a first unit which may be cationic, for example, is able to adsorb to the cotton surface by means of electrostatic interaction, and a second unit which is hydrophobic is responsible for the active ingredient remaining at the water/cotton interface.

The color transfer inhibitors suitable for use in laundry detergents of the invention include, in particular, polyvinylpyrrolidones, polyvinylimidazoles, polymeric N-oxides such as poly(vinylpyridine N-oxide) and copolymers of vinylpyrrolidone with vinylimidazole.

For use in machine cleaning processes, it may be of advantage to add foam inhibitors to the agents. Examples of suitable foam inhibitors are soaps of natural or synthetic origin having a high proportion of C₁₈-C₂₄ fatty acids. Examples of suitable nonsurfactant-type foam inhibitors are organopolysiloxanes and their mixtures with microfine, optionally silanized silica and also paraffins, waxes, microcrystalline waxes, and mixtures thereof with silanized silica or bis-stearyl-ethylenediamide. With advantages, use is also made of mixtures of different foam inhibitors, for example mixtures of silicones, paraffins or waxes. The foam inhibitors, in particular those containing silicone and/or paraffin, are preferably bound to a granular, water-soluble or dispersible support substance. Particular preference is given here to mixtures of paraffins and bis-stearylethylenediamides.

Dyes and fragrances are added to detergents in order to improve the esthetic appeal of the products and to provide the consumer, in addition to washing and cleaning performance, with a visually and sensorially “typical and unmistakable” product. As perfume oils and/or fragrances it is possible to use individual odorant compounds, for example the synthetic products of the ester, ether, aldehyde, ketone, alcohol and hydrocarbon types. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenyl glycinate, allylcyclohexyl propionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamenaldehyde, hydroxycitronellal, lilial and bourgeonal; the ketones include, for example, the ionones, α-isomethylionone and methyl cedryl ketone; the alcohols include anethol, citronellol, eugenol, geraniol, linalool, phenylethyl alcohol, and terpineol; the hydrocarbons include primarily the terpenes such as limonene and pinene. Preference, however, is given to the use of mixtures of different odorants which together produce an appealing fragrance note. Such perfume oils may also contain natural odorant mixtures, as obtainable from plant sources, for example pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniper berry oil, vetiver oil, olibanum oil, galbanum oil and labdanum oil, and also orange blossom oil, neroli oil, orangepeel oil and sandalwood oil. The dye content of detergents and cleaning agents is usually less than 0.01% by weight, while fragrances may be up to 2% by weight of the overall formulation.

The fragrances may be incorporated directly into the detergents; however, it may also be advantageous to apply the fragrances to carriers which intensify the adhesion of the perfume to the material to be cleaned and, by means of slower fragrance release, ensure long-lasting fragrance, in particular of treated textiles. Materials which have become established as such carriers are, for example, cyclodextrins, it being possible, in addition, for the cyclodextrin-perfume complexes to be additionally coated with further auxiliaries. Another preferred carrier for fragrances is the described zeolite X which can also absorb fragrances instead of or in a mixture with surfactants. Preference is therefore given to detergents and cleaning agents which contain the described zeolite X and fragrances which, preferably, are at least partially absorbed to the zeolite.

Preferred dyes whose selection is by no means difficult for the skilled worker have high storage stability and insensitivity to the other ingredients of the agents and to light, and also have no pronounced affinity for textile fibers, so as not to stain them.

To control microorganisms, detergents of the invention may contain antimicrobial active ingredients. Depending on antimicrobial spectrum and mechanism of action, a distinction is made here between bacteriostatics and bactericides, fingistatics and fungicides, etc. Examples of important substances from these groups are benzalkonium chloride, alkylaryl sulfonates, halogen phenols and phenol mercury acetate. The terms antimicrobial action and antimicrobial active ingredient have, within the teaching of the invention, the meaning common in the art, which is described, for example, by K. H. Wallhäuβer in “Praxis der Sterilisation, Desinfektion—Konservierung: Keimidentifizierung—Betriebshygiene” (5th Edition, —Stuttgart; N.Y.: Thieme, 1995), it being possible to use all of the substances having antimicrobial action described there. Suitable antimicrobial active ingredients are preferably selected from the groups of alcohols, amines, aldehydes, antimicrobial acids or their salts, carboxylic esters, acid amides, phenols, phenol derivatives, diphenyls, diphenylalkanes, urea derivatives, oxygen acetals, nitrogen acetals and also oxygen and nitrogen formals, benzamidines, isothioazolines, phthalimide derivatives, pyridine derivatives, antimicrobial surfactant compounds, guanidines, antimicrobial amphoteric compounds, quinolines, 1,2-dibromo-2,4-dicyanobutane, iodo-2-propylbutyl carbamate, iodine, iodophors, peroxo compounds, halogen compounds, and any mixtures of the above.

The antimicrobial active ingredient may be selected from ethanol, n-propanol, i-propanol, 1,3-butanediol, phenoxyethanol, 1,2-propylene glycol, glycerol, undecylenic acid, benzoic acid, salicylic acid, dihydracetic acid, o-phenylphenol, N-methylmorpholinoacetonitrile (MMA), 2-benzyl-4-chlorophenol, 2,2′-methylenebis(6-bromo-4-chlorophenol), 4,4′-dichloro-2′-hydroxydiphenyl ether (dichlosan), 2,4,4′-trichloro-2′-hydroxydiphenyl ether (trichlosan), chlorohexidine, N-(4-chlorophenyl)-N-(3,4-dichlorophenyl)urea, N,N′-(1,10-decanediyldi-1-pyridinyl-4-ylidene)-bis(1-octanamine)dihydrochloride, N,N′-bis(4-chlorophenyl)-3,12-diimino-2,4,11,13-tetraazatetradecanediimidamide, glucoprotamines, antimicrobial surface-active quaternary compounds, guanidines including the bi- and polyguanidines, such as, for example, 1,6-bis(2-ethylhexylbiguanidohexane)dihydrochloride, 1,6-di-(N₁,N₁′-Phenyldiguanido-N₅,N₅′)hexane tetrahydrochloride, 1,6-di-(N₁,N₁′-phenyl-N₁,N₁-methyl-diguanido-N₅,N₅′)hexane dihydrochloride, 1,6-di-(N₁,N₁′-o-chlorophenyldiguanido-N₅,N₅′)hexane dihydrochloride, 1,6-di-(N₁,N₁′-2,6-dichlorophenyldiguanido-N₅,N₅′)hexane dihydrochloride, 1,6-di-[N₁,N₁′-beta-(p-methoxyphenyl)diguanido-N₅,N₅′]hexane dihydrochloride, 1,6-di-(N₁,N₁′-alpha-methyl-beta-phenyldiguanido-N₅,N₅′)hexane dihydro-chloride, chloride, 1,6-di-(N₁,N₁′-p-nitrophenyldiguanido-N₅,N₅′)hexane dihydrochloride, omega:omega-di-(N₁,N₁′-phenyldiguanido-N₅,N₅′)-di-n-propyl ether dihydrochloride, omega:omega′-di-(N₁,N₁′-p-chlorophenyldiguanido-N₅,N₅′)-di-n-propyl ether tetrahydrochloride, 1,6-di-(N₁,N₁′-2,4-dichlorophenyldiguanido-N₅,N₅′)hexane tetrahydrochloride, 1,6-di-(N₁,N₁′-p-methylphenyl-diguanido-N₅,N₅′)hexane dihydrochloride, 1,6-di-(N₁,N₁′-2,4,5-trichlorophenyldiguanido-N₅,N₅′)hexane tetrahydrochloride, 1,6-di-[N₁,N₁′-alpha-(p-chlorophenyl)ethyldiguanido-N₅,N₅′]hexane dihydrochloride, omega:omega-di-(N₁,N₁′-p-chlorophenyldiguanido-N₅,N₅′)m-xylene dihydrochloride, 1,12-di-(N₁,N₁′-p-chlorophenyldiguanido-N₅,N₅′)dodecane dihydrochloride, 1,10-di-(N₁,N₁′-phenyldiguanido-N₅,N₅′)decane tetrahydrochloride, 1,12-di-(N₁,N₁′-phenyldiguanido-N₅,N₅′)dodecane tetrahydrochloride, 1,6-di-(N₁,N₁′-o-chlorophenyldiguanido-N₅,N₅′)hexane dihydrochloride, 1,6-di-(N₁,N₁′-o-chlorophenyldiguanido-N₅,N₅′)hexane tetrahydrochloride, ethylene-bis(1-tolylbiguanide), ethylene-bis(p-tolylbiguanide), ethylene-bis(3,5-dimethylphenylbiguanide), ethylene-bis(p-tert-amylphenylbiguanide), ethylene-bis(nonylphenylbiguanide), ethylene-bis(phenylbiguanide), ethylene-bis(N-butylphenylbiguanide), ethylene-bis(2,5-diethoxyphenylbiguanide), ethylene-bis(2,4-dimethylphenylbiguanide), ethylene-bis(o-diphenylbiguanide), ethylene-bis(mixed amyl naphthylbiguanide), N-butylethylene-bis(phenylbiguanide), trimethylenebis(o-tolylbiguanide), N-butyl-trimethyl-bis(phenylbiguanide) and the corresponding salts such as acetates, gluconates, hydrochlorides, hydrobromides, citrates, bisulfites, fluorides, polymaleates, N-cocoalkyl sarcosinates, phosphites, hypophosphites, perfluorooctanoates, silicates, sorbates, salicylates, maleates, tartrates, fumarates, ethylenediaminetetraacetates, iminodiacetates, cinnamates, thiocyanates, arginates, pyromellitates, tetracarboxybutyrates, benzoates, glutarates, monofluorophosphates, perfluoropropionates, and any mixtures thereof. Also suitable are halogenated xylol and cresol derivatives, such as p-chlorometacresol or p-chlorometaxylol, and natural antimicrobial active ingredients of plant origin (for example from spices or herbs), animal origin and microbial origin. Preference may be given to using antimicrobial surface-active quaternary compounds, a natural antimicrobial active ingredient of plant origin and/or a natural antimicrobial active ingredient of animal origin, most preferably at least one natural antimicrobial active ingredient of plant origin from the group comprising caffeine, theobromine and theophylline and essential oils such as eugenol, thymol and geraniol, and/or at least one natural antimicrobial active ingredient of animal origin from the group comprising enzymes such as milk protein, lysozyme and lactoperoxidase, and/or at least one antimicrobial surface-active quaternary compound having an ammonium, sulfonium, phosphonium, iodonium or arsonium group, peroxo compounds and chlorine compounds. It is also possible to use substances of microbial origin, the “bacteriocines”.

The quaternary ammonium compounds (QACs) which are suitable as antimicrobial active ingredients have the general formula (R¹)(R²)(R³)(R⁴)N⁺X⁻ where R¹ to R⁴ are identical or different C₁-C₂₂-alkyl radicals, C₇-C₂₈-aralkyl radicals or heterocyclic radicals, where two, or in the case of an aromatic incorporation as in pyridine, even three radicals, together with the nitrogen atom, form the heterocycle, for example a pyridinium or imidazolinium compound, and X⁻ are halide ions, sulfate ions, hydroxide ions or similar anions. For optimal antimicrobial action, at least one of the radicals preferably has a chain length of from 8 to 18, in particular 12 to 16, carbon atoms.

QACs can be prepared by reacting tertiary amines with alkylating agents such as, for example, methyl chloride, benzyl chloride, dimethyl sulfate, dodecyl bromide, or else ethylene oxide. The alkylation of tertiary amines having one long alkyl radical and two methyl groups proceeds particularly readily, and the quatemization of tertiary amines having two long radicals and one methyl group can also be carried out with the aid of methyl chloride under mild conditions. Amines which have three long alkyl radicals or hydroxy-substituted alkyl radicals have low reactivity and are preferably quatemized using dimethyl sulfate.

Examples of suitable QACs are benzalkonium chloride (N-alkyl-N,N-dimethylbenzylammonium chloride, CAS No. 8001-54-5), benzalkone B (m,p-dichlorobenzyl-dimethyl-C12-alkylammonium chloride, CAS No. 58390-78-6), benzoxonium chloride (benzyldodecyl-bis(2-hydroxyethyl)ammonium chloride), cetrimonium bromide (N-hexadecyl-N, N-trimethylammonium bromide, CAS No. 57-09-0), benzetonium chloride (N,N-dimethyl-N-[2-[2-[p-(1,1,3,3-tetramethylbutyl)phenoxy]ethoxy]ethyl]benzylammonium chloride, CAS No. 121-54-0), dialkyldimethylammonium chlorides such as di-n-decyldimethylammonium chloride (CAS No. 7173-51-5-5), didecyldimethylammonium bromide (CAS No. 2390-68-3), dioctyldimethylammonium chloride, 1-cetylpyridinium chloride (CAS No. 123-03-5) and thiazoline iodide (CAS No. 15764-48-1), and mixtures thereof. Particularly preferred QACs are the benzalkonium chlorides having C₈-C₁₈-alkyl radials, in particular C₁₂-C₁₄-alkylbenzyldimethylammonium chloride.

Benzalkonium halides and/or substituted benzalkonium halides are commercially available, for example, as Barquat® ex Lonza, Marquat® ex Mason, Variquat® ex Witco/Sherex and Hyamine® ex Lonza, and Bardac® ex Lonza. Further commercially available antimicrobial active ingredients are N-(3-chloroallyl)hexaminium chloride such as Dowicide® and Dowicil® ex Dow, benzethonium chloride such as Hyamine® 1622 ex Rohm & Haas, methylbenzethonium chloride such as Hyamine® 10X ex Rohm & Haas, cetylpyridinium chloride such as cepacol chloride ex Merrell Labs.

The antimicrobial active ingredients are used in amounts of from 0.0001% by weight to 1% by weight, preferably from 0.001% by weight to 0.8% by weight, particularly preferably from 0.005% by weight to 0.3% by weight, and in particular from 0.01 to 0.2% by weight.

The agents of the invention may contain UV absorbers which attach to the treated textiles and improve the light stability of the fibers and/or the light stability of other formulation constituents. UV absorbers mean organic substances (light protection filters) which are able to absorb ultraviolet radiation and tb emit the absorbed energy again in the form of radiation of longer wavelength, for example heat.

Compounds which have these desired properties are, for example, the compounds which are active via radiationless deactivation and derivatives of benzophenone having substituents in position(s) 2 and/or 4. Also suitable are substituted benzotriazoles, acrylates which are phenyl-substituted in position 3 (cinnamic acid derivatives, with or without cyano groups in position 2), salicylates, organic Ni complexes and natural substances such as umbelliferone and the endogenous urocanic acid. Of particular importance are biphenyl and especially stilbene derivatives, as described, for example, in EP 0728749 A and commercially available as Tinosorb® FD or Tinosorb® FR ex Ciba. UV-B absorbers which may be mentioned are: 3-benzylidenecamphor or 3-benzylidenenorcamphor and derivatives thereof, for example 3-(4-methylbenzylidene)camphor, as described in EP 0693471 B1; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenylcinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives such as, for example, 2,4,6-trianilino-(p-carbo-2′-ethyl-1′-hexyloxy)-1,3,5-triazine and octyltriazone, as described in EP 0818450 A1, or dioctylbutamidotriazone (Uvasorb® HEB); propane-1,3-diones such as, for example, 1-(4-tert-butylphenyl)-3-(4′-methoxyphenyl)propane-1,3-dione; ketotricyclo(5.2.1.0)decane derivatives, as described in EP 0694521 B1. Further suitable are 2-phenylbenzimidazole-5-sulfonic acid and its alkali metal, alkaline earth metal, ammonium, alkylammonium, alkanolammonium and glucammonium salts; sulfonic acid derivatives of benzophenones, preferably 2-hydroxy-4-methoxybenzophenone-5-sulfonic acid and its salts; sulfonic acid derivatives of 3-benzylidenecamphor, such as, for example, 4-(2-oxo-3-bomylidenemethyl)benzenesulfonic acid and 2-methyl-5-(2-oxo-3-bomylidene)sulfonic acid and salts thereof.

Suitable typical UV-A filters are, in particular, derivatives of benzoylmethane, such as, for example, 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds, as described in DE 19712033 A1 (BASF). The UV-A and UV-B filters may of course also be used in mixtures. In addition to said soluble substances, insoluble light protection pigments, namely finely dispersed, preferably nanoized, metal oxides or salts, are also suitable for this purpose. Examples of suitable metal oxides are, in particular, zinc oxide and titanium dioxide and also oxides of iron, zirconium, silicon, manganese, aluminum and cerium, and mixtures thereof. Salts which may be used are silicates (talc), barium sulfate or zinc stearate. The oxides and salts are already used in the form of the pigments for skin care and skin-protective emulsions and decorative cosmetics. The particles here should have an average diameter of less than 100 nm, preferably between 5 and 50 nm, and in particular between 15 and 30 nm. They can have a spherical shape, but it is also possible to use particles which have an ellipsoidal shape or a shape deviating in some other way from the spherical form. The pigments may also be surface-treated, i.e. hydrophilicized or hydrophobicized. Typical examples are coated titanium dioxides such as, for example, titanium dioxide T 805 (Degussa) or Eusolex® T2000 (Merck); suitable hydrophobic coating agents are here preferably silicones and, particularly preferably, trialkoxyoctylsilanes or simethicones. Preference is given to using micronized zinc oxide. Further suitable UV light protection filters can be found in the review by P. Finkel in SÖFW-Journal 122 (1996), p. 543.

The U absorbers are usually used in amounts of from 0.01% by weight to 5% by weight, preferably from 0.03% by weight to 1% by weight.

To increase the washing or cleaning performance, agents of the invention may contain enzymes, it being possible in principle to use any enzymes established for these purposes in the prior art. These include in particular proteases, amylases, lipases, hemicellulases, where appropriate additional cellulases, or oxidoreductases, and preferably mixtures thereof. Said enzymes are in principle of natural origin; starting from the natural molecules, improved variants are available for use in detergents and cleaning agents and preferably used accordingly. Agents of the invention preferably contain total amounts of enzymes of from 1×10⁻⁶ to 5 percent by weight based on active protein. The protein concentration may be determined with the aid of known methods, for example the BCA method (bicinchoninic acid; 2,2′-biquinolyl-4,4′-dicarboxylic acid) or the biuret method (A. G. Gornall, C. S. Bardawill and M. M. David, J Biol. Chem., 177(1948), pp. 751-766).

Among the proteases, preference is given to those of the subtilisin type. Examples of these include the subtilisins BPN' and Carlsberg, protease PB92, subtilisins 147 and 309, Bacillus lentus alkaline protease, subtilisin DY and the enzymes thermitase, proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsvwrd, Denmark. The subtilisins 147 and 309 are sold under the trade names Esperase® and, respectively, Savinase® by Novozymes. The variants listed under the name BLAP® which are described in particular in WO 92/21760 A1, WO 95/23221 A1, WO 02/088340 A2 and PCT/EP02/11725 (not yet published) are derived from the protease of Bacillus lentus DSM 5483 (WO 91/02792 A1). Other usable proteases from various Bacillus sp. and B. gibsonii are disclosed in the patent applications DE 10162727, DE 10163883, DE 10163884 and DE 10162728 which have not yet been published.

Further examples of useful proteases are the enzymes available under the trade names Durazym®, Relase®, Everlase®, Nafizym, Natalase®, Kannase® and Ovozymes® from Novozymes, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan and that under the name Proteinase K-16 from Kao Corp., Tokyo, Japan.

Examples of amylases which may be used according to the invention are the α-amylases from Bacillus licheniformis, from B. amyloliquefaciens or from B. stearothermophilus and developments thereof which have been improved for use in detergents and cleaning agents. The B. licheniformis enzyme is available from Novozymes under the name Termamyl® and from Genencor under the name Purastar®ST. Development products of this α-amylase are obtainable from Novozymes under the trade names Duramyl® and Termamyl®ultra, from Genencor under the name Purastar®OxAm and from Daiwa Seiko Inc., Tokyo, Japan as Keistase®. The B. amyloliquefaciens α-amylase is sold by Novozymes under the name BAN® and variants derived from B. stearothermophilus α-amylase under the names BSG® and Novamyl®, likewise from Novozymes.

Enzymes for this purpose which must be mentioned are furthermore the α-amylase from Bacillus sp. A 7-7 (DSM 12368), disclosed in the application WO 02/10356 A2, and the cyclodextrin glucanotransferase (CGTase) from B. agaradherens (DSM 9948), described in the application WO 02/44350 A2. Also usable are the amylolytic enzymes belonging to the sequence region of α-amylases, which is defined in the application PCT/EP02/06842, and those described in the still unpublished application DE 10163748 A1. It is also possible to use fusion products of the molecules mentioned, for example those of the still unpublished application PCT/EP02/08391.

Also suitable are the developments of α-amylase from Aspergillus niger and A. oryzae, which are available under the trade names Fungamyl® from Novozymes. Another commercial product is Amylase-LT®, for example.

Agents of the invention may comprise lipases or cutinases, in particular due to their triglyceride-cleaving activities, but also in order to generate in situ peracids from suitable precursors. Examples thereof include the lipases which were originally obtainable from Humicola lanuginosa (Thermomyces lanuginosus) which have been developed further, in particular those with the amino acid substitution D96L. They are sold, for example, under the trade names Lipolase®, Lipolase®Ultra, LipoPrime®, Lipozyme® and Lipex® from Novozymes. Further examples which may be used are the cutinases which have originally been isolated from Fusarium solani pisi and Humicola insolens. Lipases which are also useful can be obtained under the designations Lipase CE®, Lipase P®, Lipase B®, Lipase CES®, Lipase AKG®, Bacillis sp. Lipase®, Lipase AP®, Lipase M-AP® and Lipase AML® from Amano. Examples of lipases and cutinases from Genencor which may be used are those whose starting enzymes have originally been isolated from Pseudomonas mendocina and Fusarium solanii. Other important commercial products which may be mentioned are the preparations M1 Lipase® and Lipomax® originally sold by Gist Brocades and the enzymes sold under the names Lipase MY-30®, Lipase OF® and Lipase PL® by Meito Sangyo KK, Japan, and also the product Lumafast® from Genencor.

Agents of the invention may, in particular when intended for the treatment of textiles, comprise further cellulases, depending on the purpose either as pure enzymes, as enzyme preparations or in the form of mixtures in which the individual components advantageously complement one another with respect to their different performance aspects. These performance aspects include in particular contributions to the primary washing performance, to the secondary washing performance of the agent (antiredeposition action or graying inhibition) and finishing (fabric action), up to exerting a “stone-washed” effect. Thus it is possible to set particularly desired performance focal points by combination with cellulases important to the invention.

A useful fungal, endoglucanase (EG)-rich cellulase preparation and developments thereof are supplied under the trade name Celluzyme® from Novozymes. The products Endolase® and Carezyme® likewise available from Novozymes are based on the H. insolens DSM 1800 50 kD EG and 43 kD EG, respectively. Further commercial products of this company, which may be used, are Cellusoft® and Renozyme®. The latter is based on the application WO 96/29397 A1. The application WO 98/12307 A1, for example, discloses performance-enhanced cellulase variants. The cellulases disclosed in the application WO 97/14804 A1 may also be used; for example, the Melanocarpus 20 kD EG disclosed therein, which is available under the trade names Ecostone® and Biotouch® from AB Enzymes, Finland. Other commercial products from AB Enzymes are Econase® and Ecopulp®. Further suitable cellulases from Bacillus sp. CBS 670.93 and CBS 669.93 are disclosed in WO 96/34092 A2, with that from Bacillis sp. CBS 670.93 being available under the trade name Puradex® from Genencor. Other commercial products from Genencor are Genencor detergent cellulase L and IndiAge®Neutra.

Agents of the invention may comprise, in particular for removing particular problematic soilings, further enzymes classified under the term hemicellulases. These include, for example, mannanases, xanthane lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1L from AB Enzymes and under the name Pyrolase® from Diversa Corp., San Diego, Calif., USA. The application WO 99/06573 A1, for example, discloses a suitable β-glucanase from a B. alcalophilus. The P-glucanase isolated from B. subtilis is available under the name Cereflo® from Novozymes.

In order to increase the bleaching action, detergents and cleaning agents of the invention may comprise oxidoreductases, for example oxidases, oxygenases, catalases, peroxidases such as haloperoxidases, chloroperoxidases, bromoperoxidases, lignin peroxidases, glucose peroxidases or manganese peroxidases, dioxygenases or laccases (phenol oxidases, polyphenol oxidases). Suitable commercial products which may be mentioned are Denilite® 1 and 2 from Novozymes. Advantageously and additionally preferably organic, particularly preferably aromatic, compounds interacting with said enzymes are added in order to enhance the activity of the oxidoreductases concerned (enhancers), or to ensure electron flow in the case of large differences in the redox potentials of the oxidizing enzymes and the soilings (mediators).

The enzymes used in agents of the invention either derive originally from microorganisms, for example of the genera Bacillus, Streptomyces, Humicola, or Pseudomonas, and/or are produced by suitable microorganisms, for example by transgenic expression hosts of the genera Bacillus or filamentous fungi, according to biotechnological processes known per se.

The purification of the enzymes in question is advantageously carried out via processes established per se, for example via precipitation, sedimentation, concentration, filtration of the liquid phases, microfiltration, ultrafiltration, the action of chemicals, deodorizing or suitable combinations of these steps.

These enzymes, as well as the enzyme important to the invention, may be added to the agents of the invention in any forms that are customary for the formulation of enzymes or seem appropriate for the presentation of the particular agent. They may be used in dry agents, for example in dried, granulated, encapsulated or encapsulated and additionally dried form. They may be added separately, i.e. as a separate phase, or together with other components in the same phase, with or without compaction. If microencapsulated enzymes are intended to be processed in solid form, it is possible to remove the water from the aqueous solutions resulting from the work-up by using methods known in the prior art, such as spray drying, removing by centrifugation or resolubilizing.

The encapsulated form is a way of protecting the enzymes against other components such as, for example, bleaches, or of making possible a controlled release. Depending on their size, said capsules are divided into milli-, micro- and nanocapsules, microcapsules being particularly preferred for enzymes. Such capsules are disclosed, for example, in the patent applications WO 97/24177 and DE 199 18 267. A further possible encapsulation method is to encapsulate the enzymes, starting from a mixture of the enzyme solution with a solution or suspension of starch or a starch derivative, in starch or said starch derivative. German application DE 199 56 382 entitled “Verfahren zur Herstellung von mikroverkapselten Enzymen” [Method of preparing microencapsulated enzymes] describes such a method.

An encapsulation in cellulose or in cellulose derivatives is also possible. Via simultaneous use of cellulases and of cellulose capsules, or of capsules made of cellulose-like materials which may also be used for other ingredients, a controlled release of these ingredients is conceivable.

It is possible to add to gelatinous or paste-like agents of the invention the enzymes as well as the protein important to the invention, starting from protein isolation carried out according to the prior art, and preparation in a concentrated aqueous or nonaqueous solution, for example in liquid form, for example as a solution, suspension or emulsion, but also in gel form or encapsulated or as dried powder. Methods of preparing enzyme concentrates are known from the prior art, for example microfiltration or ultrafiltration. Such detergents of the invention in the form of solutions in customary solvents are usually prepared by simply mixing the ingredients which may be introduced as solids or as solution into an automated mixer.

A protein and/or enzyme present in an agent of the invention may be protected, particularly during storage, from damage such as, for example, inactivation, denaturation or decay, for example by physical influences, oxidation or proteolytic cleavage. When obtaining the proteins and/or enzymes microbially, particular preference is given to inhibiting proteolysis, in particular when the agents also contain proteases. For this purpose, preferred agents of the invention contain stabilizers.

One group of stabilizers are reversible protease inhibitors. To this end, benzamidine hydrochloride, borax, boric acids, boronic acids or salts or esters thereof are frequently used, including especially derivatives with aromatic groups, for example ortho-, meta- or para-substituted phenylboronic acids, in particular 4-formylphenylboronic acid, or the salts or esters of said compounds. Peptide aldehydes, i.e. oligopeptides with reduced C terminus, in particular those composed of 2 to 50 monomers, are also used for this purpose. The peptidic reversible protease inhibitors include, inter alia, ovomucoid and leupeptin. Specific, reversible peptide inhibitors of the protease subtilisin and fusion proteins of proteases and specific peptide inhibitors are also suitable for this.

Further enzyme stabilizers are amino alcohols such as mono-, di-, triethanol- and -propanolamine and mixtures thereof, aliphatic carboxylic acids up to C₁₂, such as, for example, succinic acids, other dicarboxylic acids or salts of said acids. End group-capped fatty amide alkoxylates are also suitable for this purpose. As disclosed in WO 97/18287, particular organic acids used as builders are capable of additionally stabilizing an enzyme present.

Lower aliphatic alcohols, and especially polyols such as, for example, glycerol, ethylene glycol, propylene glycol or sorbitol, are other frequently used enzyme stabilizers. Diglycerol phosphate also protects against denaturation by physical influences. Calcium salts and/or magnesium salts are also used, such as calcium acetate or calcium formate, for example.

Polyamide oligomers or polymeric compounds such as lignin, water-soluble vinyl copolymers or cellulose ethers, acryl polymers and/or polyamides stabilize the enzyme preparation inter alia against physical influences or pH fluctuations. Polyamine N-oxide-containing polymers simultaneously act as enzyme stabilizers and as color transfer inhibitors. Other polymeric stabilizers are the linear C₈-C₁₈ polyoxyalkylenes. Alkylpolyglycosides can also stabilize the enzymic components of the agent of the invention and are preferably capable of additionally increasing their performance. Crosslinked N-containing compounds preferably fulfill a double function as soil release agents and as enzyme stabilizers. Hydrophobic, nonionic polymer stabilizes in particular a cellulase which may or may not be present.

Reducing agents and antioxidants increase the stability of the enzymes against oxidative decay; familiar examples thereof are sulfur-containing reducing agents. Other examples are sodium sulfite and reducing sugars.

Particular preference is given to using combinations of stabilizers, for example of polyols, boric acid and/or borax, the combination of boric acid or borate, reducing salts and succinic acid or other dicarboxylic acids or the combination of boric acid or borate with polyols or polyamino compounds and with reducing salts. The action of peptide-aldehyde stabilizers is advantageously increased by combination with boric acid and/or boric acid derivatives and polyols and still further by the additional action of divalent cations such as calcium ions, for example.

A separate subject matter of the invention are processes for washing textiles, which are characterized in that an above-described detergent comprising cellulase is used in at least one of the process steps.

This relates to any cleaning processes for cleaning textiles or comparable materials, including manual, but in particular machine cleaning processes. According to the previous comments, appropriate preference is given to processes in which the agents illustrated above are used.

Especially machine cleaning processes are distinguished by multistage cleaning programs according to which various cleaning-active components are applied in a time-resolved manner to the material to be cleaned. Thus, the invention also encompasses those processes in which, during a partial step, only one cellulase important to the invention and the stimulating cellulose are contacted with the material to be washed, preferably in a suitable reaction medium.

The use of a detergent comprising cellulase, illustrated above, for washing textiles, in particular in a process illustrated above, is a separate subject matter of the invention.

This relates to all possible uses for cleaning textiles or comparable materials, including the manual, but in particular machine, use. Based on the previous comments, corresponding preference is given to uses in which the agents illustrated above are used or are components of the processes illustrated above.

A separate subject matter of the invention is the use of a cellulose which is present, at least partially, in a form which has been compacted under mechanical pressure and then granulated, preferably as very finely divided cellulose-containing material, and/or which has not been chemically modified and/or which has disintegrating action, for stimulating the contribution of a cellulase to the washing performance, in particular to the secondary washing performance, of a detergent.

The above-described preferred celluloses are correspondingly preferred for this use.

Since the application examples demonstrated that the cellulose important to the invention increases the secondary washing performance of cellulolytic enzymes even when present in an uncompressed and/or swollen state, this use of the invention does not require said cellulose to be used simultaneously as disintegrant in agents of the invention. Accordingly, such a cellulose may also be used only for the purpose of promoting the washing performance, in particular the antiredeposition action of cellulases. It may be added only for this purpose to cellulase-containing agents or introduced in an appropriate step of a cleaning process.

For this, it need not necessarily be in a compressed state. Embodiments are thus those in which, independently of the tablet disintegrant or completely without simultaneous use of a tablet disintegrant, a cellulose important to the invention is used in order to stimulate the secondary washing performance of a cellulase present. This applies in particular to the uncompacted presentations of detergents such as powders or gelatinous agents, for example. They may also be extruded agents. Further embodiments of this subject matter of the invention are those in which the detergents are present in the shape of shaped bodies. In addition, the detergents may comprise further ingredients whose function is to further improve the secondary washing performance and/or to enable or improve a disintegrating action.

### EXAMPLES

### Example 1

Textiles composed of the four different types of fabric, (A) WFK cotton fabric, (B) cotton/bleached cheesecloth, (C) cotton terry and (D) cotton knit, were washed in the presence of a standardized artificial pigment soil additive in commercial washing machines, using various detergent formulations. This was carried out in each case at 40° C. using the normal program of the Miele® Novotronic W 918 washing machine, at a water hardness of 16° German hardness and with 76 g of detergent per washing run. This washing process was carried out in each case 5 times in total.

The control detergent was the following basic formulation (basis; all values in percent by weight): 4% linear alkyl-benzenesulfonate (sodium salt), 4% C₁₂-C₁₈ fatty alcohol sulfate (sodium salt), 5.5% C₁₂-C₁₈ fatty alcohol with 7 EO, 1% sodium soap, 11% sodium carbonate, 2.5% amorphous sodium disilicate, 5% zeolite A, 4.5% polycarboxylate, 0.5% phosphonate, 2.5% foam inhibitor granules, 5% sodium sulfate, 1.2% protease granules, rest: water, optical brighteners, perfume, salts.

To this basic formulation, 0, 1 or 5% by weight Arbocel® cellulose TF 30 HG (Rettenmaier, Rosenberg) and two different cellulases were added. The latter are (A) the cellulase from Bacillus sp. CBS 670.93 (BCE 103), described in the patent application EP 739982, and (B) the 20 kD cellulase from Melanocarpus albomyces CBS 685.95, described in the patent application WO 97/14804. Cellulase A was used at a concentration of 5.25 CMC-U per application and cellulase B was used at a concentration of 4.57 CMC-U per application. The cellulase activity indicated in CMC-U can be determined according to the modified method by M. Lever (Anal. Biochem., 47 (1972), pp. 273-279 and Anal. Biochem., 81 (1977), pp. 21-27), illustrated in the specification.

After washing, the degree of whiteness of the washed textiles was measured in comparison to that of barium sulfate, with the latter having been normalized to 100%. The measurement was carried out in a Datacolor SF500-2 spectrometer at 460 nm (UV blocking filter 3), 30 mm diaphragm, without gloss, D65 illuminant, 10°, d/8°. Table 1 below summarizes the results obtained as percent remission, i.e. as percentages in comparison with barium sulfate. Indicated are the results for all detergent formulations, for all four types of fabric and an average for the four types of fabric (Ø). They allow a conclusion to be drawn about the contributions of the varying ingredients to the washing performance of the particular agent.

TABLE 1
5 washes with 4 different types of fabric and 9 different
detergent formulations with varying cellulose and cellulase contents

| No. | Formulation | A | B | C | D | Ø |
|---|---|---|---|---|---|---|
| 1 | Basis | 60.3 | 58.7 | 62.7 | 60.3 | 60.5 |
| 2 | + 1% Arbocel ® TF | 57.6 | 59.2 | 61.8 | 59.1 | 59.4 |
| | 30 HG | | | | | |
| 3 | + 5% Arbocel ® TF | 56.8 | 57.9 | 60.1 | 58.5 | 58.3 |
| | 30 HG | | | | | |
| 4 | + cellulase A | 67.2 | 69.5 | 75 | 73.5 | 71.3 |
| 5 | + cellulase B | 68.3 | 71.9 | 75.9 | 75 | 72.8 |
| 6 | + 1% Arbocel ® TF | 68.0 | 70.6 | 75.3 | 75.4 | 72.3 |
| | 30 HG | | | | | |
| | + cellulase A | | | | | |
| 7 | + 1% Arbocel ® TF | 70.0 | 71.6 | 76.2 | 76.1 | 73.5 |
| | 30 HG | | | | | |
| | + cellulase B | | | | | |
| 8 | +5% Arbocel ® TF | 67.6 | 70.9 | 75.2 | 74.5 | 72.1 |
| | 30 HG | | | | | |
| | + cellulase A | | | | | |
| 9 | + 5% Arbocel ®TF | 71.2 | 73.3 | 78.2 | 77.9 | 75.2 |
| | 30 HG | | | | | |
| | + cellulase B | | | | | |
| 10 | Starting value | 85.6 | 88.3 | 87.0 | 85.3 | 86.6 |
| 11 | Isd. | 1.2 | 1.0 | 0.8 | 0.9 | |

The data show that Arbocel® alone (No. 2) has no redeposition-preventing action, compared to the basic formulation (No. 1) but that both cellulases exert this action (No. 4 No. 5). There is a distinct increase in antiredeposition for the fingal cellulase B in combination with Arbocel® (Nos. 5, 7 and 9). Furthermore, this synergy effect depends on the concentration of cellulose added: an increasing amount of Arbocel® (Nos. 7 and 9) also increases the antiredeposition action of the cellulase. The, in principle, identical observation can also be made in the case of the bacterial cellulase A.

### Example 2

Example 2 was carried out as example 1 but with the difference that the textiles in question were subjected to 10 identical washing runs, under otherwise identical conditions.

TABLE 2
10 washes with 4 different types of fabric and 9 different detergent
formulations with varying cellulose and cellulase contents

| No. | Formulation | A | B | C | D | Ø |
|---|---|---|---|---|---|---|
| 1 | Basis | 51.3 | 52.1 | 55.6 | 52.5 | 52.9 |
| 2 | + 1% Arbocel ® TF | 52.5 | 52.9 | 57.7 | 52.3 | 53.9 |
| | 30 HG | | | | | |
| 3 | + 5% Arbocel ® TF | 51.7 | 52.7 | 53.7 | 51.8 | 52.5 |
| | 30 HG | | | | | |
| 4 | + Cellulase A | 63.7 | 66.4 | 70.3 | 69.4 | 67.5 |
| 5 | + Cellulase B | 65.6 | 67.8 | 71.6 | 70.6 | 68.9 |
| 6 | + 1% Arbocel ® TF | 63.2 | 66.4 | 70.3 | 70.9 | 67.7 |
| | 30 HG | | | | | |
| | + Cellulase A | | | | | |
| 7 | + 1% Arbocel ® TF | 67.3 | 69.8 | 72.7 | 72.8 | 70.7 |
| | 30 HG | | | | | |
| | + Cellulase B | | | | | |
| 8 | + 5% Arbocel ® TF | 66.1 | 68.6 | 72.8 | 72.0 | 69.9 |
| | 30 HG | | | | | |
| | + Cellulase A | | | | | |
| 9 | + 5% Arbocel ® TF | 68.5 | 71.9 | 75.7 | 74.6 | 72.7 |
| | 30 HG | | | | | |
| | + Cellulase B | | | | | |
| 10 | Staffing value | 85.6 | 88.3 | 87.0 | 85.3 | 86.6 |
| 11 | Isd. | 0.8 | 1.1 | 0.9 | 0.6 | |

The result of example 1 is also confirmed after 10 washing runs in total.

The disclosures of each patent, patent application, and publication cited or described in this document are hereby incorporated herein by reference, in their entireties.

Various modifications of the invention, in addition to those described herein, will be apparent to those skilled in the art from the foregoing description. Such modifications are also intended to fall within the scope of the appended claims.

1. A method for improving the secondary washing performance of cellulase containing detergents, comprising:
adding to said detergent a cellulose which has been compacted under mechanical pressure and then granulated.

2. The method of claim 1, wherein said cellulose is a very finely divided cellulose-containing material.

3. The method of claim 1, wherein said cellulose is not chemically modified.

4. A detergent comprising:
a cellulase, and
a disintegrant comprising granulated cellulose that has not been chemically modified.

5. The detergent of claim 4, wherein said disintegrant is a very finely divided cellulose-containing material.

6. The detergent of claim 4, wherein the proportion of the cellulose present is from 1 to 10% by weight of the detergent.

7. The detergent of claim 4, wherein the proportion of the cellulose present is from 2 to 7.5% by weight of the detergent.

8. The detergent of claim 4, wherein the proportion of the cellulose present is from 3 to 5% by weight of the detergent.

9. The detergent of claim 4, wherein the cellulase has a ratio of tensile strength loss (TSL) to antipilling properties (AP) of less than 1.

10. The detergent of claim 4, wherein the total activity of the cellulase is from 0.5 CMC-U to 40 CMC-U per 100 g of the detergent.

11. The detergent of claim 4, wherein the total activity of the cellulase is from 1 CMC-U to 30 CMC-U per 100 g of the detergent.

12. The detergent of claim 4, wherein the total activity of the cellulase is from 2 CMC-U to 20 CMC-U, per 100 g of the detergent.

13. The detergent of claim 4, further comprising an additional cellulase.

14. The detergent of claim 13, wherein the cellulase mixture has a ratio of tensile strength loss (TSL) to antipilling properties (AP) of less than 1.

15. The detergent of claim 13, wherein the total activity of the cellulase mixture is from 0.5 CMC-U to 40 CMC-U per 100 g of the detergent.

16. The detergent of claim 13, wherein the total activity of the cellulase mixture is from 1 CMC-U to 30 CMC-U per 100 g of the detergent.

17. The detergent of claim 13, wherein the total activity of the cellulase mixture is from 2 CMC-U to 20 CMC-U, per 100 g of the detergent.

18. A shaped body, comprising the detergent of claim 4.

19. The shaped body of claim 18, wherein the cellulose has been compacted under mechanical pressure and then granulated.

20. The shaped body of claim 18, further comprising chemically modified cellulose or cellulose derivatives.

21. A process for washing textiles, comprising contacting the textile with a detergent of claim 4.
